(19) United States
(12) Patent Application Publication
(10) Pub. No.: US 2026/0284899 A1
(43) Pub. Date: Sep. 24, 2026

(54) Behavior Control System, Program, and Autonomous Learning Method

(71) Applicant: Softbank Group Corp., Tokyo (JP)

(72) Inventors: Masayoshi Son, Minato-ku, Tokyo (JP); Kosuke Tomonaga, Minato-ku, Tokyo (JP)

(21) Appl. No.: 19/473,059

(22) PCT Filed: Apr. 9, 2024
(86) PCT No.: PCT/JP2024/014443

§ 371 Date: Oct. 6, 2025

(30) Foreign Application Priority Data
Apr. 11, 2023 (JP) 2023-064439
Apr. 14, 2023 (JP) 2023-066670
Apr. 17, 2023 (JP) 2023-067478
Apr. 17, 2023 (JP) 2023-067495
Apr. 19, 2023 (JP) 2023-068894
Apr. 28, 2023 (JP) 2023-075286

(51) Int. Cl. B25J 11/00; A63H 3/02; B25J 13/00; G06V 40/16; G10L 15/22; G10L 25/63

(52) U.S. Cl. CPC B25J 11/001; A63H 3/02; B25J 13/003; G06V 40/174; G10L 15/22; G10L 25/63; A63H 2200/00

(57) ABSTRACT

A robot is caused to perform a behavior appropriate for a behavior of a user. For this purpose, a behavior control system includes: an emotion determination unit that determines an emotion of a user or an emotion of a robot; and a behavior determination unit that generates a behavior content of the robot for the behavior of the user and the emotion of the user or the emotion of the robot based on a dialogue function that causes the user and the robot to have a dialogue with each other, and determines the behavior of the robot corresponding to the behavior content. The emotion determination unit determines the emotion of the user according to a specific mapping.

### TECHNICAL FIELD

The present disclosure relates to a behavior control system, a program, and an autonomous learning method.

### BACKGROUND ART

Japanese Patent No. 6053847 discloses a technology for determining an appropriate behavior of a robot for a state of a user. In the related art of Japanese Patent No. 6053847, a reaction of the user in a case where the robot performs a specific behavior is recognized, and in a case where a behavior of the robot for the recognized reaction of the user cannot be determined, the behavior of the robot is updated by receiving information regarding a behavior appropriate for a recognized state of the user from a server.

Japanese Patent No. 6273314 discloses a method of generating an emotion of a robot from a pseudo hormone based on various types of sensing data. Japanese Patent No. 6273313 discloses a method of operating a neural network based on a method of generating an emotion of a robot from a pseudo hormone based on various types of sensing data. Japanese Patent No. 6199927 discloses a technology in which an event that evokes strong emotions for the robot is retained for a longer time, and an event that elicits little emotional response from the robot is quickly forgotten.

### SUMMARY OF INVENTION

### Technical Problem

However, in the related art, there is room for improvement in causing the robot to perform an appropriate behavior for a behavior of the user.

### Solution to Problem

According to the first aspect of the disclosure, a behavior control system is provided. The behavior control system includes: an emotion determination unit that determines an emotion of a user or an emotion of a robot; and a behavior determination unit that generates a behavior content of the robot for a behavior of the user and the emotion of the user or the emotion of the robot based on a dialogue function of causing the user and the robot to have a dialogue with each other, and determines a behavior of the robot corresponding to the behavior content, in which the emotion determination unit determines the emotion of the user according to a specific mapping.

Here, the robot includes a device that performs a physical operation and a device that outputs a video or a sound without performing a physical operation.

According to a second aspect of the disclosure, a behavior control system is provided. The behavior control system includes: an emotion determination unit that determines an emotion of a user or an emotion of a robot; and a behavior determination unit that generates a behavior content of the robot for a behavior of the user and the emotion of the user or the emotion of the robot based on a dialogue function of causing the user and the robot to have a dialogue with each other, and determines a behavior of the robot corresponding to the behavior content, in which the behavior determination unit generates the behavior content of the robot for a state related to the emotion of the robot determined in advance for each type of emotion of the robot and for each intensity of the emotion, and the behavior of the user.

According to a third aspect of the disclosure, in the behavior control system according to the second aspect, the behavior determination unit generates the behavior content of the robot for a state related to the emotion of the robot determined in advance for an index number assigned to be different for each type of emotion of the robot and for each intensity of the emotion in advance, and the behavior of the user.

According to a fourth aspect of the disclosure, in the behavior control system according to the second aspect, the behavior determination unit generates the behavior content of the robot for a state related to the emotion of the robot determined in advance for each type of emotion and each intensity of the emotion, a state related to the emotion of the user determined in advance for each type of emotion of the user and each intensity of the emotion, and the behavior of the user.

According to a fifth aspect of the disclosure, in the behavior control system according to the second aspect, the behavior determination unit generates the behavior content of the robot for a state related to the emotion of the robot determined in advance for an index number assigned to be different for each type of emotion of the robot and for each intensity of the emotion in advance, a state related to the emotion of the user determined in advance for an index number assigned to be different for each type of emotion of the user and for each intensity of the emotion in advance, and the behavior of the user.

According to a sixth aspect of the disclosure, in the behavior control system according to the second aspect, the robot is mounted on a stuffed toy or is connected wirelessly or by wire to control target equipment mounted on a stuffed toy.

According to a seventh aspect of the disclosure, a behavior control system is provided. The behavior control system includes: an emotion determination unit that determines an emotion of a user or an emotion of a robot; and a behavior determination unit that generates a behavior content of the robot for a behavior of the user and the emotion of the user or the emotion of the robot based on a dialogue function of causing the user and the robot to have a dialogue with each other, and determines a behavior of the robot corresponding to the behavior content, in which the behavior determination unit accumulates, in history data, at least one of the emotion of the user, the emotion of the robot, an input to the dialogue function, and the behavior content of the robot, and generates the behavior content for the behavior of the user by the dialogue function based on the history data.

According to an eighth aspect of the disclosure, in the behavior control system according to the seventh aspect, the robot is mounted on a stuffed toy or is connected wirelessly or by wire to control target equipment mounted on a stuffed toy.

According to a ninth aspect of the disclosure, a behavior control system is provided. The behavior control system includes: a user state recognition unit that recognizes a user state including a behavior of a user; an emotion determination unit that determines an emotion of the user or an emotion of a robot; and a behavior determination unit that determines a behavior of the robot corresponding to the user state and the emotion of the user or the emotion of the robot based on a dialogue function of causing the user and the robot to have a dialogue with each other, in which the robot is mounted on an animal-like or character-like housing having a predetermined elastic force and covered with a reversible skin material, or is connected wirelessly or by wire to at least control target equipment necessary for having a dialogue with the user, and the control target equipment is disposed inside the housing.

According to a tenth aspect of the disclosure, in the behavior control system according to the ninth aspect, the housing is a stuffed toy covered with a cloth skin.

According to an eleventh aspect of the disclosure, in the behavior control system according to the ninth aspect, the control target equipment is a camera, a microphone, or a speaker.

According to a twelfth aspect of the disclosure, in the behavior control system according to the ninth aspect, the camera is attached to an eye included in a face of the animal-like or character-like housing, the microphone is attached to an ear, and the speaker is attached to a mouth.

According to a thirteenth aspect of the disclosure, in the behavior control system according to the ninth aspect, a wireless power receiving unit that receives wireless power supply from an external wireless power transmitting unit is disposed inside the housing, and the control target equipment or the robot receives power via the wireless power receiving unit.

According to a fourteenth aspect of the disclosure, a behavior control system is provided. The behavior control system includes: a user state recognition unit that recognizes a user state including a behavior of a user; an emotion determination unit that determines an emotion of the user or an emotion of a robot; and a behavior determination unit that determines a behavior of the robot corresponding to the user state and the emotion of the user or the emotion of the robot based on a dialogue function of causing the user and the robot to have a dialogue with each other, in which the robot is mounted on an animal-like or character-like housing having a predetermined elastic force and covered with a reversible skin material, or is connected wirelessly or by wire to at least control target equipment necessary for having a dialogue with the user, and the robot and the control target equipment are detachably disposed inside the housing so as to be removable to an outside of the housing.

According to a fifteenth aspect of the disclosure, in the behavior control system according to the fourteenth aspect, the housing is a stuffed toy covered with a cloth skin, and is washable by removing the robot and the control target equipment.

According to a sixteenth aspect of the disclosure, in the behavior control system according to the fourteenth aspect, the robot is a smartphone, the control target equipment is a camera communicably connected to the smartphone, and the smartphone performs information exchange with communication equipment possessed by the user.

According to a seventeenth aspect of the disclosure, in the behavior control system according to the fourteenth aspect, the camera is attached to an eye included in a face of the animal-like or character-like housing.

According to an eighteenth aspect of the disclosure, in the behavior control system according to the fourteenth aspect, a lens unit of the camera has a mechanism attachable to and detachable from the eye.

According to a nineteenth aspect of the disclosure, in the behavior control system according to the fourteenth aspect, a wireless power receiving unit that receives wireless power supply from an external wireless power transmitting unit is disposed inside the housing, and the robot receives power via the wireless power receiving unit.

According to a twentieth aspect of the disclosure, a program for causing a computer to function as the behavior control system is provided.

According to a twentieth aspect of the disclosure, an autonomous learning method is provided. The autonomous learning method may include a learning step of autonomously starting learning based on an emotion of a robot in a state in which the robot is not having a conversation.

According to a twenty-first aspect of the disclosure, in the autonomous learning method according to the twentieth aspect, in the learning step, an impressive memory of the robot may be specified from a history of the emotion of the robot, and the learning may be performed based on the impressive memory. The autonomous learning method may include: a question generation step of automatically generating a question; and an answer acquisition step of acquiring an answer to the question, in which in the learning step, self-learning may be performed by repeating the question generation step and the answer acquisition step. In the question generation step, the question may be automatically generated based on an impressive memory specified from a history of a past emotion value of the robot in a state in which a trigger from an outside is not received. The autonomous learning method may include a search execution step of automatically performing keyword search and acquiring a search result, in which in the learning step, self-learning may be performed by repeating the search execution step. In the search execution step, the keyword search may be automatically performed based on an impressive memory specified from a history of a past emotion value of the robot in a state in which a trigger from an outside is not received.

According to a twenty-second aspect of the disclosure, in the autonomous learning method according to the twentieth aspect, a program for causing a computer to execute the autonomous learning method is provided.

According to a twenty-third aspect of the disclosure, there is provided an autonomous learning device that executes the autonomous learning method according to the twentieth aspect.

Note that the summary of the invention described above does not enumerate all the necessary features of the disclosure. Further, a sub-combination of these feature groups can also be the invention.

### BRIEF DESCRIPTION OF DRAWINGS

FIG. 1 schematically shows an example of a system 5 according to the present embodiment.

FIG. 2 schematically shows a functional configuration of a robot 100.

FIG. 3 schematically shows an example of an operation flow of the robot 100.

FIG. 4 schematically shows an example of a hardware configuration of a computer 1200.

FIG. 5 shows an emotion map 400 in which a plurality of emotions are mapped.

FIG. 6 shows an emotion map 900 in which a plurality of emotions are mapped.

FIG. 7(A) is an external view of a stuffed toy according to a first other embodiment, and FIG. 7(B) is an internal structural view of the stuffed toy.

FIG. 8 is a rear front view of the stuffed toy according to the first other embodiment.

FIG. 9 is an internal structural view of a stuffed toy according to a second other embodiment.

FIG. 10(A) is a rear front view of the stuffed toy according to the second other embodiment, FIG. 10(B) is a cross-sectional view taken along line VIIIB-VIIIB of FIG. 8(A), and FIG. 10(C) is a perspective view of the vicinity of a camera unit.

FIG. 11 is a side cross-sectional view of a stuffed toy according to a modified example of the second other embodiment.

FIG. 12 schematically shows an example of an autonomous learning system 2100 according to the present embodiment.

### DESCRIPTION OF EMBODIMENTS

Hereinafter, the present disclosure will be described through embodiments of the invention, but the following embodiments do not limit the invention according to the claims. In addition, not all combinations of features described in the embodiments are essential to the solution of the invention.

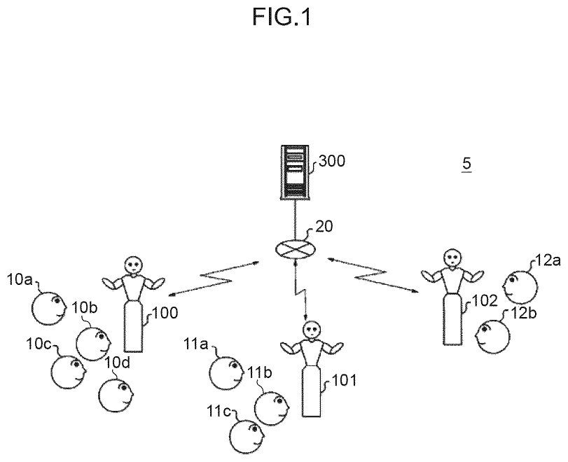

FIG. 1 schematically shows an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. In the description of the present embodiment, the user 10a, the user 10b, the user 10c, and the user 10d may be collectively referred to as the user 10. Further, the user 11a, the user 11b, and the user 11c may be collectively referred to as the user 11. Further, the user 12a and the user 12b may be collectively referred to as the user 12. The robot 101 and the robot 102 have substantially the same functions as that of the robot 100. Therefore, the system 5 will be described focusing on the function of the robot 100.

The robot 100 has a conversation with the user 10 and provides a video to the user 10. At this time, the robot 100 has a conversation with the user 10, provides a video to the user 10, and the like in cooperation with the server 300 and the like that can perform communication via a communication network 20. For example, the robot 100 not only learns an appropriate conversation by itself, but also performs learning to have a more appropriate conversation with the user 10 in cooperation with the server 300. Further, the robot 100 causes the server 300 to record captured video data and the like of the user 10, requests the server 300 to transmit the video data and the like if necessary, and provides the video data and the like to the user 10.

Further, the robot 100 has an emotion value representing a type of an emotion thereof. For example, the robot 100 has the emotion value representing an intensity of each of emotions “joy”, “anger”, “sorrow”, “pleasure”, “comfort”, “discomfort”, “relief”, “anxiety”, “sadness”, “excitement”, “worry”, “reassurance”, “sense of fulfillment”, “sense of emptiness”, and “neutral”. For example, in the case of having a conversation with the user 10 in a state in which the emotion value of excitement is large, the robot 100 utters a speech at a high speed. As described above, the robot 100 can express the emotion thereof by a behavior.

Further, the robot 100 may be configured to determine a behavior of the robot 100 corresponding to an emotion of the user 10 by matching a sentence generation model and an emotion engine using an artificial intelligence (AI) chat engine or an AI. Specifically, the robot 100 may be configured to recognize a behavior of the user 10, determine the emotion of the user 10 for the behavior of the user, and determine the behavior of the robot 100 corresponding to the determined emotion.

More specifically, in a case where the behavior of the user 10 is recognized, the robot 100 automatically generates a content of a behavior to be performed by the robot 100 for the behavior of the user 10 using a preset chat engine. The chat engine may be interpreted as an algorithm and operation for text-based automatic dialogue processing. Since the chat engine is known as disclosed in, for example, Japanese Patent Application Laid-Open No. 2018-081444 and chatGPT (Internet search <URL: https://openai.com/blog/chatgpt>), a detailed description thereof is omitted. Such a chat engine is implemented by a large language model (LLM).

As described above, in the present embodiment, it is possible to reflect the emotions of the user 10 and the robot 100 and various types of linguistic information in the behavior of the robot 100 by combining the large language model and the emotion engine. That is, according to the present embodiment, a synergistic effect can be obtained by combining the chat engine and the emotion engine.

Further, the robot 100 has a function of recognizing the behavior of the user 10. The robot 100 recognizes the behavior of the user 10 by analyzing a face image of the user 10 acquired by a camera function and a speech of the user 10 acquired by a microphone function. The robot 100 determines a behavior to be performed by the robot 100 based on the recognized behavior of the user 10 or the like.

The robot 100 stores a rule setting a behavior to be performed by the robot 100 based on the emotion of the user 10, the emotion of the robot 100, and the behavior of the user 10, and performs various behaviors according to the rule.

Specifically, the robot 100 has a reaction rule for determining the behavior of the robot 100 based on the emotion of the user 10, the emotion of the robot 100, and the behavior of the user 10. In the reaction rule, for example, a behavior of “laughing” is set as the behavior of the robot 100 for a case where the behavior of the user 10 is “laughing”. Further, in the reaction rule, a behavior of “apologizing” is set as the behavior of the robot 100 for a case where the behavior of the user 10 is “getting angry”. Further, in the reaction rule, a behavior of “answering” is set as the behavior of the robot 100 for a case where the behavior of the user 10 is “asking a question”. In the reaction rule, a behavior of “calling out” is set as the behavior of the robot 100 for a case where the behavior of the user 10 is “being sad”.

In a case where the robot 100 recognizes that the behavior of the user 10 is “getting angry”, the robot 100 selects the behavior of “apologizing” set in the reaction rule as a behavior to be performed by the robot 100 based on the reaction rule. For example, in a case where the behavior of “apologizing” is selected, the robot 100 performs the behavior of “apologizing” and outputs a speech representing words of “apology”.

Further, in a case where a condition that the emotion of the robot 100 is “neutral” (that is, “joy”=0, “anger”=0, “sorrow”=0, and “pleasure”=0) and a state of the user 10 is “alone and looking lonely” is satisfied, a content of a change in the emotion of the robot 100 to “worried” is determined, and it is determined that the behavior of “calling out” can be performed.

In a case where the robot 100 recognizes that the current emotion of the robot 100 is “neutral” and the user 10 is alone and looks lonely, the emotion value of “sorrow” of the robot 100 is increased based on the reaction rule. Further, the robot 100 selects the behavior of “calling out” set in the reaction rule as a behavior to be performed for the user 10. For example, in a case where the behavior of “calling out” is selected, the robot 100 converts a phrase “What's wrong?” expressing that the robot 100 is worried into a sympathetic voice, and outputs the voice.

Further, the robot 100 transmits, to the server 300, user reaction information indicating that a positive reaction has been obtained from the user 10 for the behavior. Examples of the user reaction information include the user behavior of “getting angry”, the behavior of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. Then, the server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into the reaction rule thereof.

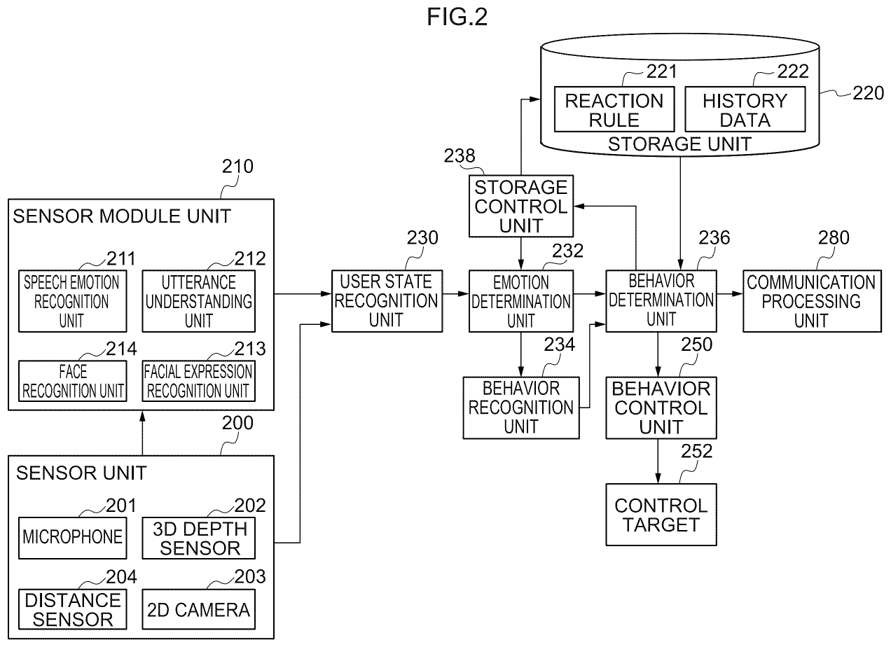

FIG. 2 schematically shows a functional configuration of the robot 100. The robot 100 includes a sensor unit 200, a sensor module unit 210, a storage unit 220, a user state recognition unit 230, an emotion determination unit 232, a behavior recognition unit 234, a behavior determination unit 236, a storage control unit 238, a behavior control unit 250, a control target 252, and a communication processing unit 280.

The control target 252 includes a display device, a speaker, a light emitting diode (LED) of an eye portion, motors that drive an arm, a hand, a foot, and the like, and the like. A posture and a gesture of the robot 100 are controlled by controlling the motors for the arm, the hand, the foot, and the like. Some emotions of the robot 100 can be expressed by controlling the motors. Furthermore, a facial expression of the robot 100 can be expressed by controlling a light emission state of the LED of the eye portion of the robot 100. The posture, the gesture and the facial expression of the robot 100 are examples of an attitude of the robot 100.

The sensor unit 200 includes a microphone 201, a 3D depth sensor 202, a 2D camera 203, and a distance sensor 204. The microphone 201 continuously detects a speech and outputs speech data. The microphone 201 may be provided at a head portion of the robot 100 and may have a function of performing binaural recording. The 3D depth sensor 202 detects an outline of an object by continuously radiating an infrared pattern and analyzing the infrared pattern based on an infrared image continuously captured by an infrared camera. The 2D camera 203 is an example of an image sensor. The 2D camera 203 performs imaging with visible light and generates video information of visible light. The distance sensor 204 detects a distance to an object by emitting, for example, a laser beam or an ultrasonic wave. The sensor unit 200 may further include a clock, a gyro sensor, a touch sensor, a sensor for motor feedback, and the like.

Among the components of the robot 100 shown in FIG. 2, the components other than the control target 252 and the sensor unit 200 are examples of components included in a behavior control system included in the robot 100. The behavior control system of the robot 100 controls the control target 252.

The storage unit 220 includes a reaction rule 221 and history data 222. The history data 222 includes a history of the past emotion value and behavior of the user 10. The history of the emotion value and the behavior is recorded for each user 10 by being associated with identification information of the user 10, for example, and accumulated in the history data 222. At least a part of the storage unit 220 is implemented by a storage medium such as a memory. A person DB that stores a face image of the user 10, attribute information of the user 10, and the like may be included. Among the components of the robot 100 shown in FIG. 2, functions of the components other than the control target 252, the sensor unit 200, and the storage unit 220 can be implemented by a CPU operating based on a program. For example, the functions of the components can be implemented as an operation of the CPU by basic software (operating system (OS)) and a program operating on the OS.

The sensor module unit 210 includes a speech emotion recognition unit 211, an utterance understanding unit 212, a facial expression recognition unit 213, and a face recognition unit 214. Information detected by the sensor unit 200 is input to the sensor module unit 210. The sensor module unit 210 analyzes the information detected by the sensor unit 200 and outputs an analysis result to the user state recognition unit 230.

The speech emotion recognition unit 211 of the sensor module unit 210 analyzes a speech of the user 10 detected by the microphone 201 to recognize the emotion of the user 10. For example, the speech emotion recognition unit 211 extracts a feature amount such as a frequency component of a speech and recognizes the emotion of the user 10 based on the extracted feature amount. The utterance understanding unit 212 analyzes the speech of the user 10 detected by the microphone 201 and outputs text information indicating an utterance content of the user 10.

The facial expression recognition unit 213 recognizes a facial expression of the user 10 and the emotion of the user 10 from an image of the user 10 captured by the 2D camera 203. For example, the facial expression recognition unit 213 recognizes the facial expression and the emotion of the user 10 based on shapes, positional relationships, and the like of the eyes and the mouth.

The face recognition unit 214 recognizes the face of the user 10. The face recognition unit 214 recognizes the user 10 by matching a face image stored in the person DB (not shown) with a face image of the user 10 captured by the 2D camera 203.

The user state recognition unit 230 recognizes a state of the user 10 based on the information analyzed by the sensor module unit 210. For example, processing mainly related to perception is performed using an analysis result of the sensor module unit 210. For example, perception information such as “Dad is alone” and “There is a 90% probability that dad is not smiling” is generated. Processing of understanding the meaning of the generated perception information is performed. For example, semantic information such as “Dad is alone and looks lonely” is generated.

The emotion determination unit 232 determines an emotion value indicating the emotion of the user 10 based on the information analyzed by the sensor module unit 210 and the state of the user 10 recognized by the user state recognition unit 230. For example, the emotion value indicating the emotion of the user 10 is acquired by inputting the information analyzed by the sensor module unit 210 and the recognized state of the user 10 to a neural network trained in advance.

Here, the emotion value indicating the emotion of the user 10 is a value indicating whether the emotion of the user is positive or negative. For example, the emotion value has a positive value in a case where the emotion of the user is a bright emotion accompanied by pleasure or a sense of calm, such as “joy”, “pleasure”, “comfort”, “relief”, “excitement”, “reassurance”, or “sense of fulfillment”, and the emotion value becomes larger as the emotion becomes brighter. The emotion value has a negative value in a case where the emotion of the user is an unpleasant emotion such as “anger”, “sorrow”, “discomfort”, “anxiety”, “sadness”, “worry”, or “sense of emptiness”, and the more unpleasant the emotion is, the larger the absolute value of the negative value becomes. In a case where the emotion of the user is not any of the above (“neutral”), the emotion value has a value of 0.

Further, the emotion determination unit 232 determines an emotion value indicating the emotion of the robot 100 based on the information analyzed by the sensor module unit 210 and the state of the user 10 recognized by the user state recognition unit 230. The emotion value of the robot 100 includes an emotion value for each of a plurality of emotion classifications, and is, for example, a value (0 to 5) indicating an intensity of each of “joy”, “anger”, “sorrow”, and “pleasure”.

Specifically, the emotion determination unit 232 determines the emotion value indicating the emotion of the robot 100 according to a rule for updating the emotion value of the robot 100, the rule being set in association with the information analyzed by the sensor module unit 210 and the state of the user 10 recognized by the user state recognition unit 230.

For example, in a case where the user state recognition unit 230 recognizes that the user 10 looks lonely, the emotion determination unit 232 increases the emotion value of “sorrow” of the robot 100. Further, in a case where the user state recognition unit 230 recognizes that the user 10 is smiling, the emotion determination unit 232 increases the emotion value of “joy” of the robot 100.

The emotion determination unit 232 may determine the emotion value indicating the emotion of the robot 100 in further consideration of a state of the robot 100. For example, in a case where the remaining battery level of the robot 100 is low, a case where the surrounding environment of the robot 100 is dark, or the like, the emotion determination unit 232 may increase the emotion value of “sorrow” of the robot 100. Furthermore, in the case of the user 10 who continues to speak to the robot 100 despite the low remaining battery level, the emotion determination unit 232 may increase the emotion value of “anger”.

The behavior recognition unit 234 recognizes the behavior of the user 10 based on the information analyzed by the sensor module unit 210 and the state of the user 10 recognized by the user state recognition unit 230. For example, a probability of each of a plurality of predetermined behavior classifications (for example, “laughing”, “getting angry”, “asking a question”, and “being sad”) is acquired by inputting the information analyzed by the sensor module unit 210 and the recognized state of the user 10 to the neural network trained in advance, and a behavior classification having the highest probability is recognized as the behavior of the user 10.

As described above, in the present embodiment, the robot 100 acquires an utterance content of the user 10 after specifying the user 10, but in acquiring and using the utterance content, the behavior control system of the robot 100 according to the present embodiment considers protection of personal information and privacy of the user 10 in addition to acquisition of necessary consent according to laws and regulations from the user 10.

The behavior determination unit 236 determines a behavior corresponding to the behavior of the user 10 recognized by the behavior recognition unit 234, based on the current emotion value of the user 10 determined by the emotion determination unit 232, the history data 222 of the past emotion value determined by the emotion determination unit 232 before the current emotion value of the user 10 is determined, and the emotion value of the robot 100. In the present embodiment, a case where the behavior determination unit 236 uses one most recent emotion value included in the history data 222 as the past emotion value of the user 10 is described, but the disclosed technology is not limited to such an aspect. For example, the behavior determination unit 236 may use a plurality of most recent emotion values as the past emotion values of the user 10, or may use emotion values from a unit period earlier, such as one day ago, as the past emotion values of the user 10. Further, the behavior determination unit 236 may determine the behavior corresponding to the behavior of the user 10 in further consideration of the history of the past emotion value of the robot 100 in addition to the current emotion value of the robot 100. The behavior determined by the behavior determination unit 236 includes the gesture made by the robot 100 or an utterance content of the robot 100.

The behavior determination unit 236 according to the present embodiment determines, as the behavior corresponding to the behavior of the user 10, the behavior of the robot 100 based on a combination of the past emotion value and the current emotion value of the user 10, the emotion value of the robot 100, the behavior of the user 10, and the reaction rule 221. For example, in a case where the past emotion value of the user 10 is a positive value and the current emotion value is a negative value, the behavior determination unit 236 determines a behavior for positively changing the emotion value of the user 10 as the behavior corresponding to the behavior of the user 10.

In the reaction rule 221, the behavior of the robot 100 based on a combination of the past emotion value and the current emotion value of the user 10, the emotion value of the robot 100, and the behavior of the user 10 is set. For example, a combination of a gesture and an utterance content when encouraging the user 10 with a gesture is set as the behavior of the robot 100 in a case where the past emotion value of the user 10 is a positive value, the current emotion value is a negative value, and the behavior of the user 10 is being sad.

For example, in the reaction rule 221, behaviors of the robot 100 are set for all combinations of patterns of the emotion value of the robot 100 (1296 patterns which correspond to the fourth power of six values of “0” to “5” of “joy”, “anger”, “sorrow”, and “pleasure”), patterns of a combination of the past emotion value and the current emotion value of the user 10, and a behavior pattern of the user 10. That is, for each pattern of the emotion value of the robot 100, the behavior of the robot 100 based on the behavior pattern of the user 10 is determined for each of a plurality of combinations of the past emotion value and the current emotion value of the user 10, such as a combination of a negative value and a negative value, a combination of a negative value and a positive value, a combination of a positive value and a negative value, a combination of a positive value and a positive value, a combination of a negative value and a value indicating the neutral emotion, and a combination of a value indicating the neutral emotion and a value indicating the neutral emotion. The behavior determination unit 236 may transition to an operation mode of determining the behavior of the robot 100 by using the history data 222, for example, in a case where the user 10 has made an utterance that intends to continue a conversation of the past topic, such as “I want to talk about the topic we discussed earlier”. In the reaction rule 221, at least one of a gesture and a statement content may be set as the behavior of the robot 100 for each pattern (1296 patterns) of the emotion value of the robot 100, with at most one behavior per pattern. Alternatively, in the reaction rule 221, at least one of the gesture and the statement content may be set as the behavior of the robot 100 for each group of the patterns of the emotion values of the robot 100.

An intensity of each gesture included in the behavior of the robot 100 and set in the reaction rule 221 is set in advance. An intensity of each utterance content included in the behavior of the robot 100 and set in the reaction rule 221 is set in advance.

The storage control unit 238 determines whether or not to store data including the behavior of the user 10 in the history data 222 based on a predetermined behavior intensity for the behavior determined by the behavior determination unit 236 and the emotion value of the robot 100 determined by the emotion determination unit 232. Specifically, in a case where the total sum of the emotion values of the plurality of emotion classifications of the robot 100 and a total intensity value, which is the sum of the predetermined intensity for the gesture included in the behavior determined by the behavior determination unit 236 and the predetermined intensity for the utterance content included in the behavior determined by the behavior determination unit 236, are equal to or larger than thresholds, the storage control unit 238 determines to store the data including the behavior of the user 10 in the history data 222.

In a case where the storage control unit 238 determines to store the data including the behavior of the user 10 in the history data 222, the behavior determined by the behavior determination unit 236, the information (for example, any surrounding information such as data such as a sound, an image, and a scent at that time) analyzed by the sensor module unit 210 over a certain period prior to the current time point, and the state (for example, the facial expression or emotion of the user 10) of the user 10 recognized by the user state recognition unit 230 are stored in the history data 222.

The behavior control unit 250 controls the control target 252 based on the behavior determined by the behavior determination unit 236. For example, in a case where the behavior determination unit 236 determines a behavior including an utterance, the behavior control unit 250 causes the speaker included in the control target 252 to output a speech. At this time, the behavior control unit 250 may determine an utterance speed of the speech based on the emotion value of the robot 100. For example, the behavior control unit 250 determines a higher utterance speed as the emotion value of the robot 100 is larger. In this manner, the behavior control unit 250 determines an execution mode of the behavior determined by the behavior determination unit 236 based on the emotion value determined by the emotion determination unit 232.

The behavior control unit 250 may recognize a change in the emotion of the user 10 for execution of the behavior determined by the behavior determination unit 236. For example, the change in the emotion may be recognized based on the speech or facial expression of the user 10. In addition, the change in the emotion of the user 10 may be recognized based on detection of an impact applied to the touch sensor included in the sensor unit 200. In a case where an impact is detected by the touch sensor included in the sensor unit 200, it may be recognized that the emotion of the user 10 has become worse, and in a case where it is determined that the reaction of the user 10 is smiling or being happy based on a detection result of the touch sensor included in the sensor unit 200, it may be recognized that the emotion of the user 10 has been improved. Information indicating the reaction of the user 10 is output to the communication processing unit 280.

Further, after the behavior control unit 250 performs the behavior determined by the behavior determination unit 236 in the execution mode determined according to the emotion of the robot 100, the emotion determination unit 232 further changes the emotion value of the robot 100 based on the reaction of the user for the execution of the behavior. Specifically, the emotion determination unit 232 increases the emotion value of “joy” of the robot 100 in a case where the reaction of the user for the behavior determined by the behavior determination unit 236 and performed for the user in the execution form determined by the behavior control unit 250 is not negative, and the emotion determination unit 232 increases the emotion value of “sorrow” of the robot 100 in a case where the reaction of the user for the behavior determined by the behavior determination unit 236 and performed for the user in the execution form determined by the behavior control unit 250 is negative.

Furthermore, the behavior control unit 250 expresses the emotion of the robot 100 based on the determined emotion value of the robot 100. For example, in a case where the emotion value of “joy” of the robot 100 is increased, the behavior control unit 250 controls the control target 252 to cause the robot 100 to make a joyful gesture. Further, in a case where the emotion value of “sorrow” of the robot 100 is increased, the behavior control unit 250 controls the control target 252 such that the posture of the robot 100 becomes a drooping posture.

The communication processing unit 280 is responsible for communication with the server 300. As described above, the communication processing unit 280 transmits the user reaction information to the server 300. Further, the communication processing unit 280 receives the updated reaction rule from the server 300. In a case where the updated reaction rule is received from the server 300, the communication processing unit 280 updates the reaction rule 221.

The server 300 performs communication between the server 300 and the robot 100, the robot 101, and the robot 102, receives the user reaction information transmitted from the robot 100, and updates the reaction rule based on a reaction rule including a behavior for which a positive reaction has been obtained.

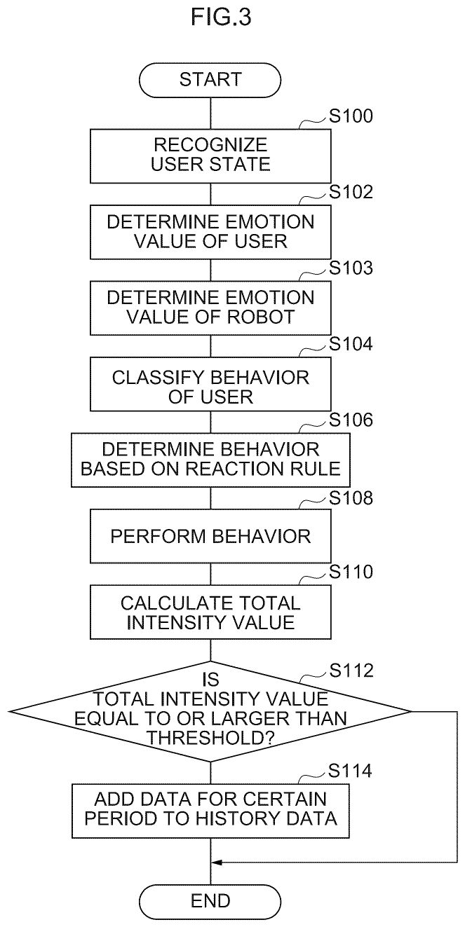

FIG. 3 schematically shows an example of an operation flow related to an operation of determining a behavior in the robot 100. The operation flow shown in FIG. 3 is repeatedly performed. At this time, it is assumed that the information analyzed by the sensor module unit 210 is input. “S” in the operation flow represents a step to be performed.

First, in step S100, the user state recognition unit 230 recognizes the state of the user 10 based on the information analyzed by the sensor module unit 210.

In step S102, the emotion determination unit 232 determines the emotion value indicating the emotion of the user 10 based on the information analyzed by the sensor module unit 210 and the state of the user 10 recognized by the user state recognition unit 230.

In step S103, the emotion determination unit 232 determines the emotion value indicating the emotion of the robot 100 based on the information analyzed by the sensor module unit 210 and the state of the user 10 recognized by the user state recognition unit 230. The emotion determination unit 232 adds the determined emotion value of the user 10 to the history data 222.

In step S104, the behavior recognition unit 234 recognizes a behavior classification of the user 10 based on the information analyzed by the sensor module unit 210 and the state of the user 10 recognized by the user state recognition unit 230.

In step S106, the behavior determination unit 236 determines the behavior of the robot 100 based on the combination of the current emotion value of the user 10 determined in step S102 and the past emotion value included in the history data 222, the emotion value of the robot 100, the behavior of the user 10 recognized by the behavior recognition unit 234, and the reaction rule 221.

In step S108, the behavior control unit 250 controls the control target 252 based on the behavior determined by the behavior determination unit 236.

In step S110, the storage control unit 238 calculates the total intensity value based on the predetermined behavior intensity for the behavior determined by the behavior determination unit 236 and the emotion value of the robot 100 determined by the emotion determination unit 232.

In step S112, the storage control unit 238 determines whether or not the total intensity value is equal to or larger than the threshold. In a case where the total intensity value is smaller than the threshold, the data including the behavior of the user 10 is not stored in the history data 222, and the processing ends. On the other hand, in a case where the total intensity value is equal to or larger than the threshold, the processing proceeds to step S114.

In step S114, the behavior determined by the behavior determination unit 236, the information analyzed by the sensor module unit 210 over a certain period prior to the current time point, and the state of the user 10 recognized by the user state recognition unit 230 are stored in the history data 222.

As described above, with the robot 100, the emotion value indicating the emotion of the robot 100 is determined based on the state of the user, and whether or not to store the data including the behavior of the user 10 in the history data 222 is determined based on the emotion value of the robot 100. As a result, a volume of the history data 222 that stores the data including the behavior of the user 10 can be reduced. Then, for example, in a case where the robot 100 determines that the state of the user after ten years matches the state of the user from ten years earlier, the robot 100 can read the history data 222 from ten years ago to present, to the user 10, the state of the user 10 from ten years earlier (for example, the facial expression or emotion of the user 10), and further, any surrounding information such as data of a sound, an image, and a scent at that time.

Further, with the robot 100, it is possible to cause the robot 100 to perform an appropriate behavior for the behavior of the user 10. Hitherto, a behavior of the user has been classified to determine a behavior including a facial expression or appearance of the robot. On the other hand, the robot 100 determines the current emotion value of the user 10 and performs a behavior for the user 10 based on the past emotion value and the current emotion value. Therefore, for example, in a case where the user 10 who seemed fine yesterday is depressed today, the robot 100 can make an utterance such as “You seemed fine yesterday. What's wrong today?”. Further, the robot 100 can also make an utterance with a gesture. Further, for example, in a case where the user 10 who was depressed yesterday seems fine today, the robot 100 can make an utterance such as “You seemed down yesterday, but you look fine today!”. Further, for example, in a case where the user 10 who seemed fine yesterday looks better today than yesterday, the robot 100 can make an utterance such as “You look better today than yesterday. Did anything good happen since yesterday?”. Further, for example, the robot 100 can make an utterance such as “You've been in a really stable mood lately. That's great!” for the user 10 whose emotion value is 0 or more and whose emotion value fluctuation continuously remains within a certain range.

Further, for example, in a case where the robot 100 asks the user 10, “Did you finish the homework you mentioned yesterday?”, and the user 10 answers “Yeah, I did”, the robot 100 can make a positive utterance such as “Good job!” and make a positive gesture such as applause or thumbs-up. Furthermore, for example, in a case where the user 10 makes an utterance “The presentation I talked about the day before yesterday went well”, the robot 100 can make a positive utterance such as “Nice effort!” and also make the above affirmative gesture. As described above, the robot 100 performs a behavior based on a history of the state of the user 10, whereby it can be expected that the user 10 feels a sense of closeness toward the robot 100.

In the above embodiment, a case where the robot 100 recognizes the user 10 by using the face image of the user 10 has been described, but the disclosed technology is not limited to such an aspect. For example, the robot 100 may recognize the user 10 by using a voice uttered by the user 10, a mail address of the user 10, an ID of a social network service (SNS) of the user 10, an ID card in which a wireless IC tag is embedded and which is possessed by the user 10, or the like.

The robot 100 is an example of electronic equipment including the behavior control system. An application target of the behavior control system is not limited to the robot 100, and the behavior control system can be applied to various types of electronic equipment. Further, functions of a server 300 may be implemented by one or more computers. At least some functions of the server 300 may be implemented by a virtual machine. Further, at least some functions of the server 300 may be implemented on a cloud.

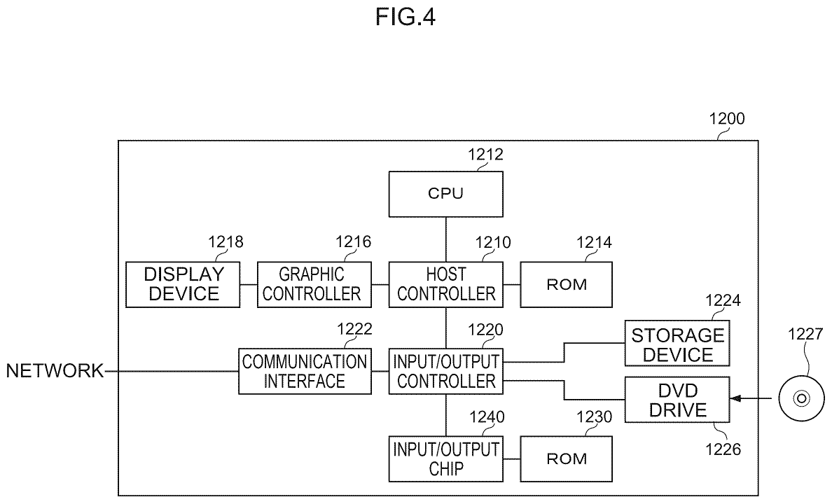

FIG. 4 schematically shows an example of a hardware configuration of a computer 1200 that functions as the robot 100 and the server 300. A program installed in the computer 1200 can cause the computer 1200 to function as one or more “units” of the device according to the present embodiment, or cause the computer 1200 to perform an operation associated with the device according to the embodiment or one or more “units” thereof, and/or can cause the computer 1200 to execute a process according to the embodiment or a stage of the process. Such a program may be executed by a CPU 1212 to cause the computer 1200 to perform a certain operation associated with some or all of the blocks in the flowcharts and block diagrams described herein.

The computer 1200 according to the embodiment includes the CPU 1212, a random access memory (RAM) 1214, and a graphics controller 1216, which are mutually connected by a host controller 1210. The computer 1200 also includes input/output units such as a communication interface 1222, a storage device 1224, a digital versatile disk (DVD) drive 1226, and an integrated circuit (IC) card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a read only memory (ROM) 1230 and a legacy input/output unit such as a keyboard, which are connected to the input/output controller 1220 via an input/output chip 1240.

The CPU 1212 operates according to the program stored in the ROM 1230 and the RAM 1214, thereby controlling each unit. The graphics controller 1216 acquires image data generated by the CPU 1212 in a frame buffer or the like provided in the RAM 1214 or itself, and causes the image data to be displayed on a display device 1218.

The communication interface 1222 communicates with other electronic devices via a network. The storage device 1224 stores the program and data to be used by the CPU 1212 in the computer 1200. The DVD drive 1226 reads the program or data from a DVD-ROM 1227 or the like and provides the program or data to the storage device 1224. The IC card drive reads the program and data from an IC card and/or writes the program and data to the IC card.

The ROM 1230 stores therein a boot program to be executed by the computer 1200 at the time of activation and/or a program that depends on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or the IC card. The program is read from the computer-readable storage medium, installed in the storage device 1224, the RAM 1214, or the ROM 1230, which is also an example of the computer-readable storage medium, and executed by the CPU 1212. Information processing described in these programs is read by the computer 1200 and provides cooperation between the programs and various types of hardware resources described above. The device or method may be configured by implementing operation or processing of information according to the use of the computer 1200.

For example, in a case where communication is performed between the computer 1200 and an external device, the CPU 1212 may execute a communication program loaded into the RAM 1214 and instruct the communication interface 1222 to execute communication processing based on processing described in the communication program. Under the control of the CPU 1212, the communication interface 1222 reads transmission data stored in a transmission buffer region provided in a recording medium such as the RAM 1214, the storage device 1224, the DVD-ROM 1227, or the IC card, transmits the read transmission data to the network, or writes reception data received from the network to a reception buffer region or the like provided on the recording medium.

In addition, the CPU 1212 may read a necessary part of or the entire file or database stored in an external recording medium such as the storage device 1224, the DVD drive 1226 (DVD-ROM 1227), the IC card, or the like into the RAM 1214, and may perform various types of processing on the data on the RAM 1214. Next, the CPU 1212 may write back the processed data to the external recording medium.

Various types of information such as various types of programs, data, tables, and databases may be stored in a recording medium and subjected to the information processing. The CPU 1212 may perform various types of processing on the data read from the RAM 1214, the various types of processing including various types of operations, the information processing, condition determination, conditional branching, unconditional branching, and information search/replacement, which are described throughout the disclosure and designated by a command sequence of a program, and write back the results to the RAM 1214. In addition, the CPU 1212 may search for information in a file, a database, or the like in the recording medium. For example, in a case where a plurality of entries each having an attribute value of a first attribute associated with an attribute value of a second attribute are stored in the recording medium, the CPU 1212 may search for an entry in which the attribute value of the first attribute satisfies a designated condition among the plurality of entries, read the attribute value of the second attribute stored in the entry, and thereby acquire the attribute value of the second attribute associated with the first attribute satisfying a predetermined condition.

The program or software module described above may be stored in a computer-readable storage medium on the computer 1200 or in the vicinity of the computer 1200. Further, a recording medium such as a hard disk or a RAM provided in a server system connected to a dedicated communication network or the Internet can be used as the computer-readable storage medium, thereby providing a program to the computer 1200 via the network.

The blocks in the flowcharts and block diagrams in the embodiment may represent stages of a process in which the operation is performed or “units” of the device that are responsible for performing the operation. Certain stages and “units” may be implemented by a dedicated circuit, a programmable circuit provided together with a computer-readable instruction stored on a computer-readable storage medium, and/or a processor provided together with the computer-readable instruction stored on the computer-readable storage medium. The dedicated circuit may include a digital and/or analog hardware circuit, and may include an integrated circuit (IC) and/or a discrete circuit. The programmable circuit may include a reconfigurable hardware circuit including, for example, AND, OR, XOR, NAND, NOR, and other logical operations, a flip-flop, a register, and a memory element, such as a field programmable gate array (FPGA) and a programmable logic array (PLA).

The computer-readable storage medium may include any tangible device capable of storing an instruction to be executed by a suitable device, so that the computer-readable storage medium having the instruction stored therein includes an article including an instruction that may be executed to create means for performing the operation specified in the flowcharts or block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disc read only memory (CD-ROM), a digital versatile disk (DVD), a Blu-Ray disk, a memory stick, and an integrated circuit card.

The computer-readable instruction may include a source code or an object code described in any combination of one or more programming languages, including an assembler instruction, an instruction-set-architecture (ISA) instruction, a machine instruction, a machine-dependent instruction, a microcode, a firmware instruction, state setting data, or an object-oriented programming language such as Smalltalk, JAVA (registered trademark), or C++, and a procedural programming language according to the related art, such as the “C” programming language or similar programming languages.

The computer-readable instruction may be provided for a processor of a general purpose computer, a special purpose computer, or another programmable data processing device, or a programmable circuit, either locally or via a local area network (LAN) or a wide area network (WAN) such as the Internet, to cause the processor of the general purpose computer, the special purpose computer, or the another programmable data processing device or the programmable circuit to execute the computer-readable instruction to generate means for performing the operation designated in the flowcharts or block diagrams. Examples of the processor include a computer processor, a processing unit, a microprocessor, a digital signal processor, a controller, and a microcontroller.

Although the disclosure has been described with reference to the embodiments, the technical scope of the disclosure is not limited to the scope described in the embodiments. It is apparent to those skilled in the art that various modifications or improvements can be made to the above embodiments. It is apparent from the description of the claims that such changed embodiments or improved embodiments can also be included in the technical scope of the disclosure.

It should be noted that an order of execution of processing such as operations, procedures, steps, and stages in the devices, systems, programs, and methods shown in the claims, the specification, and the drawings can be implemented in any order unless “before”, “prior to”, or the like is explicitly stated, and unless the output of the previous processing is used in the later processing. Even in a case where the operation flow in the claims, the specification, and the drawings is described using the terms “first”, “next”, and the like for convenience, it does not mean that it is essential to execute the operation flow in this order.

### OTHER EMBODIMENTS

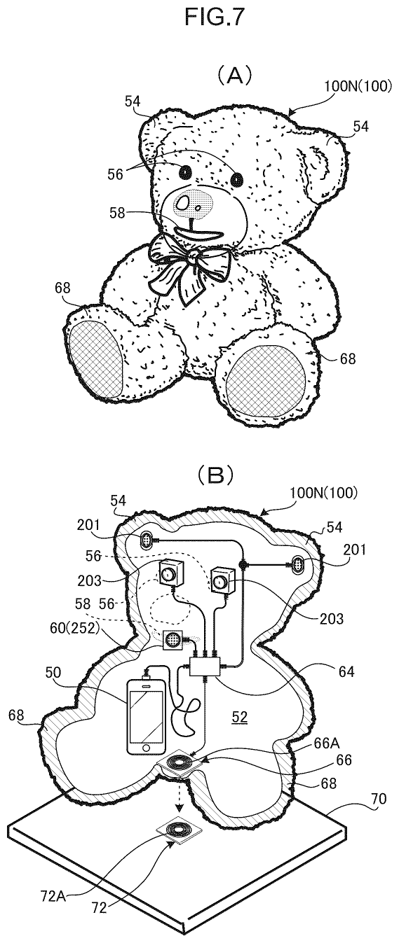

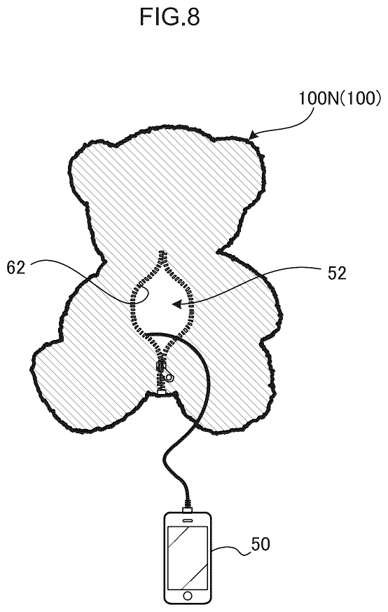

As another embodiment, the above-described robot 100 may be applied to a robot mounted on an (electrical appliance, a computer, an automobile, or a motorcycle). Further, the robot 100 may be mounted on a stuffed toy, or may be applied to a control device connected wirelessly or by wire to control target equipment (speaker or camera) mounted on a stuffed toy. Hereinafter, such an embodiment will be described as a first other embodiment. Specifically, the first other embodiment has the following configuration. For example, the robot 100 may be applied to a cohabiting companion (specifically, a stuffed toy 100N shown in FIGS. 7 and 8) that has a dialogue with the user 10 based on information regarding daily life and provides information tailored to preferences of the user 10 while spending daily life with the user 10.

The smartphone 50 functioning as a control device of the robot 100 is attachable to and detachable from the stuffed toy 100N having a function as an input/output device of the robot 100, and the input/output device and the smartphone 50 are connected inside the stuffed toy 100N.

As shown in FIG. 7(A), the stuffed toy 100N has a shape of a bear covered with a soft cloth fabric in the present embodiment (the first other embodiment), and as shown in FIG. 7(B), in a space portion 52 formed inside the stuffed toy 100N, the microphone 201 (see FIG. 2) of the sensor unit 200 is disposed as the input/output device at a portion corresponding to an ear 54, the 2D camera 203 (see FIG. 2) of the sensor unit 200 is disposed at a portion corresponding to an eye 56, and a speaker 60 forming a part of the control target 252 (see FIG. 2) is disposed at a portion corresponding to a mouth 58. The microphone 201 and the speaker 60 are not necessarily separated from each other, and may be formed as an integrated unit. In a case where the microphone 201 and the speaker 60 are formed as the unit, it is preferable to dispose the unit at a position where an utterance can be heard naturally, such as a position of a nose of the stuffed toy 100N.

The smartphone 50 serving as the control device has a function as the sensor module unit 210, a function as the storage unit 220, a function as the user state recognition unit 230, a function as the emotion determination unit 232, a function as the behavior recognition unit 234, a function as the behavior determination unit 236, a function as the storage control unit 238, a function as the behavior control unit 250, and a function as the communication processing unit 280 shown in FIG. 2.

As shown in FIG. 8, a fastener 62 is attached to a part (for example, a back portion) of the stuffed toy 100N, and the outside and the space portion 52 communicate with each other by opening the fastener 62.

Here, the smartphone 50 serving as the control device is housed in the space portion 52 from the outside and is universal serial bus (USB)-connected to each input/output device via a USB hub 64 (see FIG. 8(B)), so that functions equivalent to those of the robot 100 shown in FIG. 1 can be provided.

A non-contact power receiving plate 66 is connected to the USB hub 64. A power receiving coil 66A is incorporated in the power receiving plate 66.

The power receiving plate 66 is disposed near root portions 68 of both feet of the stuffed toy 100N and is positioned closest to a placement base 70 in a case where the stuffed toy 100N is placed on the placement base 70.

The stuffed toy 100N placed on the placement base 70 can be appreciated as an ornament in a natural state.

Further, the root portion is formed to have a thickness smaller than a thickness of a surface layer of the stuffed toy 100N at other portions, and is held in a state closer to the placement base 70.

The placement base 70 includes a charging pad 72. A power transmitting coil 72A is incorporated in the charging pad 72. When the power transmitting coil 72A transmits a signal to search the power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not shown) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the present embodiment (first other embodiment), the smartphone 50 is housed in the space portion 52 of the stuffed toy 100N and connected by wire (USB connection). However, for example, the USB hub 64 may have a wireless function (for example, “Bluetooth (registered trademark)”), and the smartphone 50 may function as the control device from the outside without being inserted into the space portion 52.

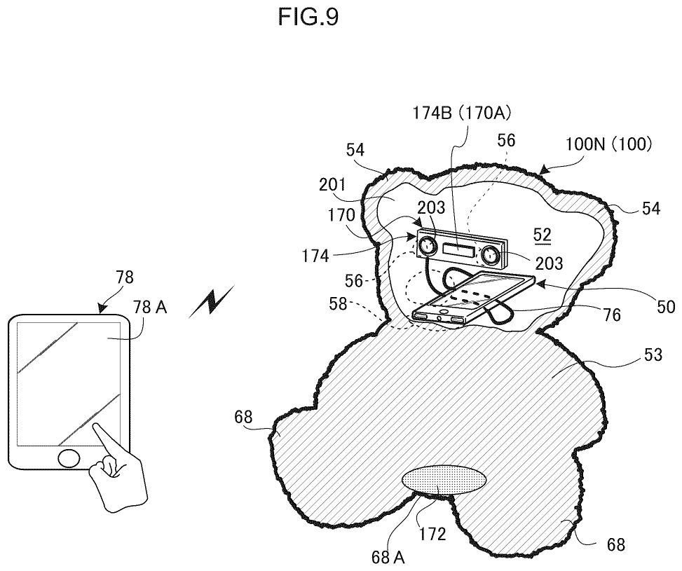

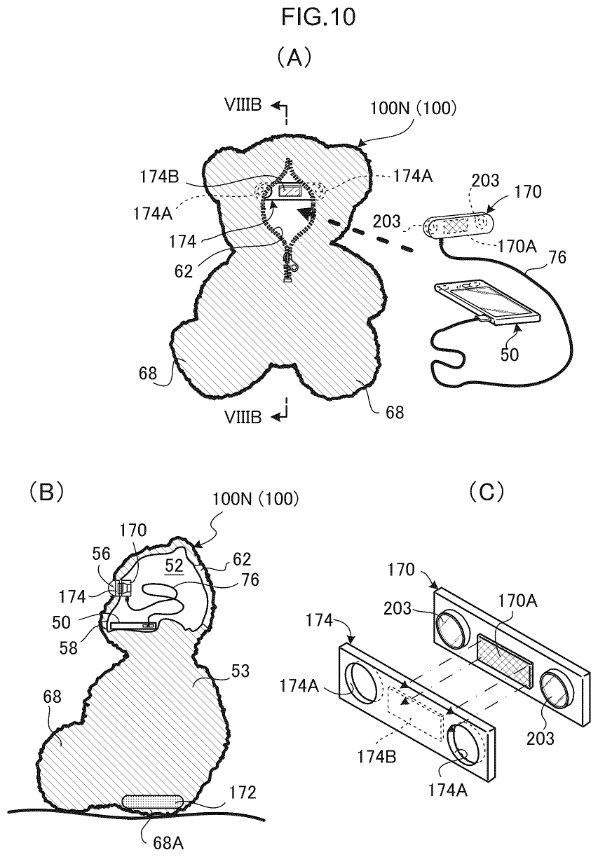

In addition, as an embodiment in which the robot 100 is mounted on the stuffed toy, the control target equipment (speaker or camera) and the control device connected wirelessly or by wire to the control target equipment may be mounted on the stuffed toy. This will be described as a second other embodiment. In the second other embodiment, an example in which a control portion of the robot 100 is applied to the smartphone 50 will be described with reference to FIGS. 9 and 10. In FIGS. 9 and 10, the same reference numerals are given to the same components as those of FIGS. 7 and 8, and a detailed description thereof will be omitted.

A camera unit 170 (see FIG. 9, which is described in detail below) functioning as an input/output device of the robot 100 and the smartphone 50 functioning as a control device are attachable to and detachable from a stuffed toy 100N. Built-in functions of the smartphone 50 are used for input/output devices (such as a microphone and a speaker) other than the camera unit 170.

As shown in FIG. 9, in a space portion 52 formed inside the stuffed toy 100N (mainly in the vicinity of a head portion), the camera unit 170 functioning as the 2D camera 203 of the sensor unit 200 is disposed at a portion corresponding to eyes 56 (see FIG. 2), and the smartphone 50 is disposed at a portion corresponding to a mouth 58.

A portion other than the space portion 52 in the stuffed toy 100N is filled with a filler 53 such as urethane, and a weight 172 is disposed at the lowermost portion (a root portion 68 of feet). With the center of gravity set by the weight 172, the stuffed toy 100N is held on a placement surface in a stable state (seated state).

Here, the smartphone 50 is placed in a substantially horizontal state such that a specific side surface (a microphone function portion and a speaker portion) of the smartphone 50 faces the mouth 58.

In the second other embodiment, the smartphone 50 is set in a state in which a microphone function and a speaker function as the input/output devices are used but a monitor function and a camera function are not used.

### (Structure of Camera Unit 170)

An attachment plate 174 to and from which the camera unit 170 is attachable and detachable is attached to a portion corresponding to the eye 56 of the stuffed toy 100N on a side of the space portion 52.

The attachment plate 174 is made of a horizontally long rectangular plate material, and is provided with a pair of circular holes 174A with a predetermined pitch dimension so as to face the portion corresponding to both eyes 56 (coaxially). A magnet 174B is attached between the pair of circular holes 174A. The magnet 174B is attachable to and detachable from a magnetic body portion 170A (such as an iron plate) attached to the camera unit 170 by a magnetic force.

As shown in FIG. 10(C), in the camera unit 170, a pair of cameras (corresponding to the 2D cameras 203 shown in FIG. 2) is attached to a housing 170B having a horizontally long rectangular shape. The 2D cameras 203 are arranged with the same pitch dimension as the pitch dimension of the pair of circular holes 174A.

The magnetic body portion 170A is attached between the pair of 2D cameras 203, and the camera unit 170 is mounted on the attachment plate 174 by a magnetic force by being brought close to the attachment plate 174.

The camera unit 170 is connected via, for example, a USB cable 76 of the smartphone 50. Therefore, in a case where a fastener 62 is opened and the smartphone 50 is moved to the inside and outside of the space 52 of the stuffed toy 100N, the camera unit 170 is held in a state of being mounted on the attachment plate 174 by a magnetic force (attachable and detachable), so that the camera unit 170 can be moved together.

According to the second other embodiment, the stuffed toy 100N can exchange information (an image, a speech, and the like) by connecting the smartphone 50 to communication equipment 78 (see FIG. 9) possessed by the user 10 by wireless communication (for example, Wi-Fi or Bluetooth (registered trademark)). Examples of the communication equipment 78 include a tablet and another smartphone.

Specifically, the stuffed toy 100N can be used not only as a dialogue partner having an artificial intelligence (functioning as the robot 100), but also as a mode such as a virtual self of the user 10 by displaying an image captured by the camera unit 170 of the stuffed toy 50 on a monitor 78A of the communication equipment 78 and outputting a speech uttered by the user 10 toward a microphone of the communication equipment 78 from the speaker function of the smartphone 50 of the stuffed toy 100N. The smartphone 50 displays an image (still image or moving image) generated by a function as the robot 100 on the monitor 78A of the communication equipment 78.

Therefore, the user 10 and the stuffed toy 100N can have a daily conversation and establish a so-called cohabiting companion relationship.

In addition, in a case where the user 10 wants to treat the stuffed toy 100N as the stuffed toy 100N, it is sufficient if the user 10 opens the fastener 62 and removes the smartphone 50 and the camera unit 170 from the space portion 52.

By removing the smartphone 50 and the camera unit 170, the stuffed toy 100N can be washed (in whole using water, liquid chemicals, or the like). In other words, a method of washing the stuffed toy 100N is not limited to dry-cleaning, air cleaning, and the like.

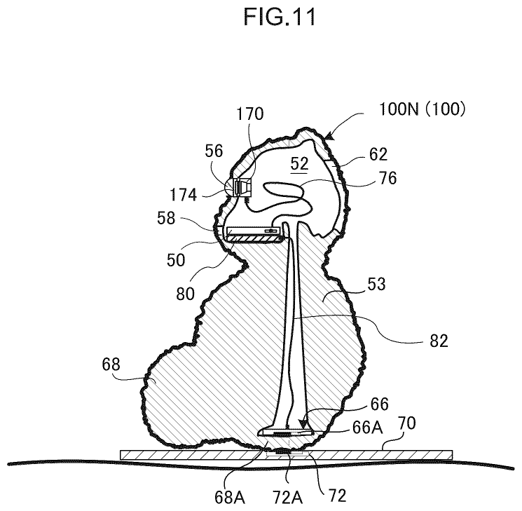

Another stuffed toy 100N of the second other embodiment may have a charging function similarly to the stuffed toy 100N of the first other embodiment. In this case, as shown in FIG. 11, a charging base 80 is disposed at a placement position of the smartphone 50 in the stuffed toy 100N. A non-contact power receiving plate 66 is connected to the charging base 80 via a charging cable 82 as in the first other embodiment. The power receiving plate 66 is disposed near root portions 68 of both feet of the stuffed toy 100N instead of the weight 172 shown in FIG. 9 and is positioned closest to a placement base 70 in a case where the stuffed toy 100N is placed on the placement base 70. The placement base 70 is an example of an external wireless power transmitting unit.

In the present embodiment (second other embodiment), the smartphone 50 is housed in the space portion 52 of the stuffed toy 100N and connected by wire (USB connection) to the camera unit 170, but the disclosure is not limited thereto.

Further, the camera unit 170 in which the control device is housed in the space portion 52 of the stuffed toy 100N and the smartphone 50 positioned outside may be wirelessly connected.

Further, in the present embodiment (first and second other embodiments), the bear-shaped stuffed toy 100N has been exemplified, but the shape of the stuffed toy 100N may be another animal, a doll, or a shape of a specific character. Further, clothes of the stuffed toy 100N may be able to be changed. Further, a material of an outer surface is not limited to the cloth fabric and may be other materials such as soft vinyl. It is preferable that the material of the outer surface is a soft material.

Further, in the present embodiment (first and second other embodiments), a monitor may be attached to the outer surface of the stuffed toy 100N, and the control target 252 that provides information to the user 10 through vision may be added. For example, the eye 56 may be used as the monitor to express joy, anger, sorrow, and pleasure, or a window through which a built-in monitor of the smartphone 50 is visible may be provided at a belly portion. Further, the eye 56 may be used as a projector to express joy, anger, sorrow, and pleasure by an image projected on a wall surface.

According to the first and second other embodiments, the existing smartphone 50 is inserted into the stuffed toy 100N, and the camera 203, the microphone 201, the speaker 60, and the like are extended from the smartphone 50 to appropriate positions via USB connection.

Furthermore, for a wireless charger, the power receiving plate 66 is USB-connected, a coil-shaped portion is extended, and the power receiving plate 66 is disposed as close to the outer side of the stuffed toy 100N as possible when viewed from the inside.

In order to use the wireless charging of the smartphone 50, the smartphone 50 needs to be positioned as close to the outer side of the stuffed toy 100N as possible when viewed from the inside, which may result in a rough tactile sensation when the stuffed toy 100N is touched from the outside.

Therefore, the stuffed toy 50 can maintain the original softness thereof by disposing the smartphone 50 as close to the center of the stuffed toy 100N as possible and disposing a wireless charging function (power receiving plate 66) as close to the outer side of the stuffed toy 100N as possible when viewed from the inside.

The robot 100 (including a robot 100 whose appearance is the stuffed toy 100N) performs dialogue processing based on a preference of the user, a situation of the user, and a reaction of the user by the following steps 1 to 5-2.

(Step 1) The robot 100 acquires a state of the user 10, an emotion value of the user 10, an emotion value of the robot 100, and history data 222. Specifically, processing similar to steps S100 to S103 is performed to acquire the state of the user 10, the emotion value of the user 10, the emotion value of the robot 100, and the history data 222.

(Step 2) The robot 100 acquires the preference of the user 10 regarding daily life. That is, the robot 100 is used as a partner in the daily life of the user 10, has a conversation regarding preferences in the daily life, and can provide appropriate information to the user 10. Examples of the appropriate information include article information including a guidance on an article desired by the user 10, a price of each article, and a purchasing method, explanatory information for explaining an event (such as weather, fortune, or explanation of news the user has seen or heard) and meanings of words and phrases (words and sentences) that the user 10 desires to know about, and schedule notification information for making a notification in advance according to a schedule of the user 10.

Specifically, the behavior determination unit 236 determines, as the behavior of the robot 100, to make an utterance for asking the user 10 about the preference regarding the daily life, and the behavior control unit 250 controls the control target 252 to make the utterance for asking the user 10 about the preference regarding the daily life. The user state recognition unit 230 recognizes the preference of the user 10 regarding the daily life based on the information (for example, an answer of the user) analyzed by the sensor module unit 210.

(Step 3) The robot 100 determines information to be proposed to the user 10.

Specifically, the behavior determination unit 236 acquires a content of a recommendation regarding a book by adding a fixed sentence such as “What book would you recommend to the user in this case?” to a text representing the preference of the user 10 regarding the daily life, the emotion of the user 10, the emotion of the robot 100, and the content stored in the history data 222 and inputting the text to an AI chat engine. At this time, it is possible to propose a book or moving image distribution information appropriate for the user 10 by considering not only the preference of the user 10 regarding the book but also the emotion of the user 10 and the history data 222. Further, it is possible to make the user 10 feel that the robot 100 has emotions by considering the emotion of the robot 100.

(Step 4) The robot 100 proposes information regarding the daily life determined in step 3 to the user 10 and acquires the reaction of the user 10.

Specifically, the behavior determination unit 236 determines, as the behavior of the robot 100, to make an utterance for proposing the information regarding the daily life to the user 10, and the behavior control unit 250 controls the control target 252 to make the utterance for proposing the information regarding the daily life to the user 10. The user state recognition unit 230 recognizes the state of the user 10 based on the information analyzed by the sensor module unit 210, and the emotion determination unit 232 determines the emotion value indicating the emotion of the user 10 based on the information analyzed by the sensor module unit 210 and the state of the user 10 recognized by the user state recognition unit 230.

The behavior determination unit 236 determines whether or not the reaction of the user 10 is positive based on the state of the user 10 recognized by the user state recognition unit 230 and the emotion value indicating the emotion of the user 10, and determines, as the behavior of the robot 100, whether to perform processing of executing the information regarding the daily life proposed to the user 10 (for example, processing of proposing a book and purchasing the book) or to propose another book to the user 10.

(Step 5-1) In a case where the reaction of the user 10 is positive, the robot 100 performs processing of executing the proposed information imposed on the daily life (for example, processing of purchasing the book after a book guidance is provided).

Specifically, in a case where it is determined to perform processing of purchasing the book proposed to the user 10 as the behavior of the robot 100, the behavior control unit 250 controls activation of an online sales execution program that is the control target 252 so as to purchase the book proposed to the user 10 (execution of online sales).

(Step 5-2) In a case where the reaction of the user 10 is not positive, the robot 100 determines another information regarding the daily life, which is proposed to the user 10 (for example, a proposal of another book).

Specifically, in a case where it is determined to propose another information regarding the daily life to the user 10 as the behavior of the robot 100, the behavior determination unit 236 acquires a content of a recommendation regarding the book by adding a fixed sentence “Are there any other recommended books for the user?” to a text representing the preference regarding the book, the emotion of the user 10, the emotion of the robot 100, and the content stored in the history data 222 for the user 10 and inputting the text to the AI chat engine. Then, the processing returns to step 4 described above, and the processing of steps 4 to 5-2 described above is repeated until it is determined to perform the processing of purchasing the book proposed to the user 10.

In this manner, the robot 100 can propose the information regarding the daily life based on the preference of the user, the situation of the user 10, and the reaction of the user 10, and perform processing according to the proposed information.

As another embodiment, the behavior determination unit 236 may generate a behavior content of the robot 100 for a state related to the emotion of the robot 100 determined in advance for each type of emotion of the robot 100 and for each intensity of the emotion, and the behavior of the user 10. Since an operation flow of the robot 100 in the embodiment is substantially the same as that shown in FIG. 3 except for processing contents of the emotion determination unit 232 and the behavior determination unit 236, processing performed by the emotion determination unit 232 and the behavior determination unit 236 will be described below.

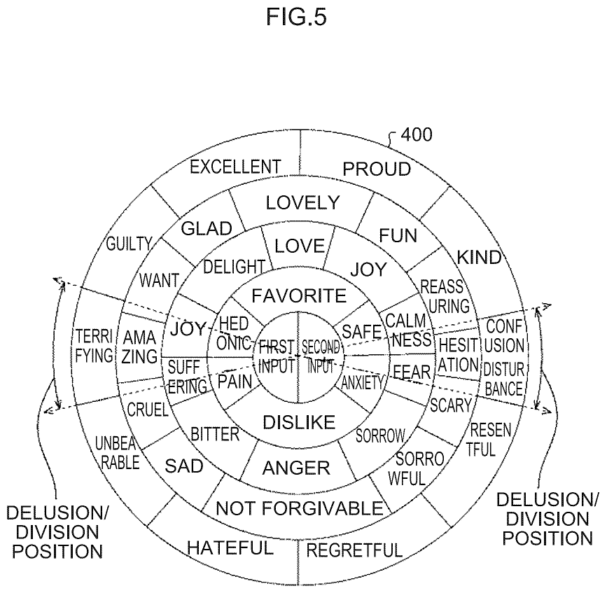

The emotion determination unit 232 may determine the emotion of the user according to a specific mapping. Specifically, the emotion determination unit 232 may determine the emotion of the user based on an emotion map (see FIG. 5) representing the specific mapping.

FIG. 5 is a diagram showing an emotion map 400 in which a plurality of emotions are mapped. In the emotion map 400, emotions are arranged radially in concentric circles from the center. The closer to the center of the concentric circle, the more primitive the emotion is. Emotions representing states and behaviors arising from a mental state are arranged on an outer side of the concentric circle. The emotion is a concept including emotional reactions and psychological conditions. Emotions arising from reactions generally occurring in the brain are arranged on a left side of the concentric circle. Emotions induced by situation determination are generally arranged on a right side of the concentric circle. Emotions arising from reactions generally occurring in the brain and induced by situation determination are arranged in an upward direction and a downward direction of the concentric circle. Further, emotions of “comfort” are arranged on an upper side of the concentric circle, and emotions of “discomfort” are arranged on a lower side of the concentric circle. As described above, in the emotion map 400, a plurality of emotions are mapped based on a structure in which emotions arise, and emotions that are likely to arise at the same time are mapped close to each other.

(1) For example, in a case where the emotion engine, which is the emotion determination unit 232 of the robot 100, detects an emotion about every 100 msec, determination of a reaction operation (for example, the backchannel response) of the robot 100 may be performed at at least a similar frequency to the detection frequency (100 msec) of the emotion engine, or may be performed at a frequency higher than the detection frequency. The detection frequency of the emotion engine may be interpreted as a sampling rate.

The emotion is detected about every 100 msec, and the reaction operation (for example, the backchannel response) is performed immediately in conjunction with the detection, whereby an unnatural backchannel response is not performed, and a natural and smooth dialogue can be implemented. The robot 100 performs the reaction operation (such as the backchannel response) according to a direction and a magnitude (intensity) in the mandala-like emotion map 400. The detection frequency (sampling rate) of the emotion engine is not limited to 100 ms, and may be changed according to a situation (such as a case of playing sports), an age of the user, or the like.

(2) According to the emotion map 400, a direction and an intensity of an emotion may be set in advance, and a backchannel response motion and an intensity of the backchannel response may be set. For example, in a case where the robot 100 feels a sense of stability, relief, or the like, the robot 100 continues to listen while nodding. In a case where the robot 100 feels anxious, lost, or suspicious, the robot 100 may tilt the head thereof or stop movement of the head.

Such emotions are distributed at 3 o'clock positions on the emotion map 400 and usually range between relief and anxiety. In the right half of the emotion map 400, since situational awareness takes precedence over internal sensations, a calm impression is conveyed.

(3) In a case where the robot 100 experiences pleasure from being praised, a filler such as “Oh” may be inserted before an utterance. In a case where the robot 100 feels a sense of pain from receiving harsh words, a filler “Ugh!” may be inserted before an utterance. Further, the robot 100 may also perform a physical reaction such as a gesture of crouching while saying “Ugh!”. Such emotions are distributed around 9 o'clock positions on the emotion map 400.

(4) In the left half of the emotion map 400, internal sensations (reactions) take precedence over situational awareness. Therefore, an impression of an involuntary reaction can be conveyed.

In a case where the robot 100 has a favorable impression through situational awareness while experiencing an internal sensation (reaction) of acceptance, the robot 100 may nod deeply while looking at the counterpart, or may utter “Mm-hmm”. In this manner, the robot 100 may produce a balanced favorable impression for the counterpart, that is, perform a behavior expressing permissiveness or tolerance toward the counterpart. Such emotions are distributed around 12 o'clock positions in the emotion map 400.

On the other hand, in a case where the robot 100 has an unfavorable impression through situational awareness while experiencing an internal sensation (reaction) of discomfort, the robot 100 may shake the head sideways, and in a case where the robot 100 feels hatred, the robot 100 may illuminate the LED of the eye in red and glare at the counterpart. Such emotions are distributed around 6 o'clock positions in the emotion map 400.

(5) Since an inner side of the emotion map 400 represents feelings and an outer side of the emotion map 400 represents behaviors, the emotions on the outer side of the emotion map 400 are more visible (appear in behaviors).

(6) In a case where the robot 100 listens to a speech of a person while feeling relief distributed around the 3 o'clock position on the emotion map 400, the robot 100 slightly nods the head vertically and says “Hmm-hmm”. However, in a case where the robot 100 feels love distributed around the 12 o'clock position, the robot 100 may perform a more forceful and deeper vertical nod.

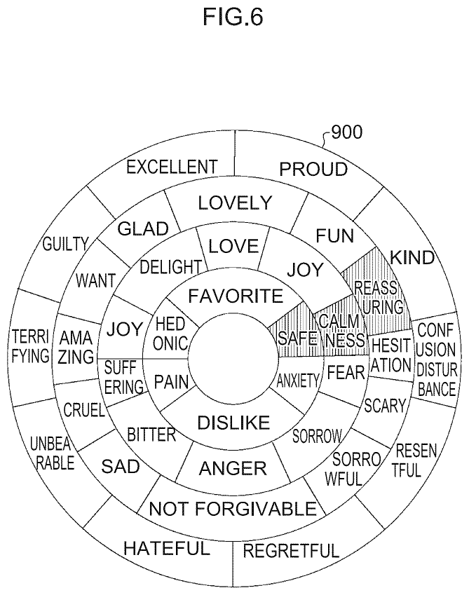

The emotion determination unit 232 inputs the information analyzed by the sensor module unit 210 and the recognized state of the user 10 to the neural network trained in advance, acquires the emotion value indicating each emotion indicated in the emotion map 400, and determines the emotion of the user 10. The neural network is trained in advance based on a plurality of pieces of learning data, which are a combination of the information analyzed by the sensor module unit 210, the recognized state of the user 10, and the emotion value indicating each emotion indicated in the emotion map 400. Furthermore, the neural network is trained such that emotions arranged close to each other as in an emotion map 900 shown in FIG. 6 have close values. FIG. 6 shows an example in which a plurality of emotions such as “relief”, “peacefulness”, and “sense of security” have similar emotion values.

Further, the emotion determination unit 232 may determine the emotion of the robot 100 according to the specific mapping. Specifically, the emotion determination unit 232 inputs the information analyzed by the sensor module unit 210, the state of the user 10 recognized by the user state recognition unit 230, and the state of the robot 100 to the neural network trained in advance, acquires the emotion value indicating each emotion indicated in the emotion map 400, and determines the emotion of the robot 100. The neural network is trained in advance based on a plurality of pieces of learning data, which are a combination of the information analyzed by the sensor module unit 210, the recognized state of the user 10, the state of the robot 100, and the emotion value indicating each emotion shown in the emotion map 400. For example, the neural network is trained based on the learning data indicating that the emotion value “3” of “joyful” is obtained in a case where it is recognized that the robot 100 is being stroked by the user 10 from an output of the touch sensor (not shown), and the learning data indicating that the emotion value “3” of “anger” is obtained in a case where it is recognized that the robot 100 is being hit by the user 10 from an output of an acceleration sensor (not shown). Furthermore, the neural network is trained such that emotions arranged close to each other as in an emotion map 900 shown in FIG. 6 have close values.

The behavior determination unit 236 generates the behavior content of the robot by adding a fixed sentence for inquiry about the behavior content of the robot corresponding to the behavior of the user to a text representing the behavior of the user, the emotion of the user, and the emotion of the robot, and inputting the text to the dialogue function.

For example, the behavior determination unit 236 acquires a text representing the state of the robot 100 from the emotion of the robot 100 determined by the emotion determination unit 232 using an emotion table as shown in Table 1. Here, in the emotion table, an index number is assigned to each emotion value for each type of emotion, and the text representing the state of the robot 100 is stored for each index number.

In a case where the emotion of the robot 100 determined by the emotion determination unit 232 corresponds to an index number “2”, a text “very pleasant state” is obtained. In a case where the emotion of the robot 100 corresponds to a plurality of index numbers, a plurality of texts representing the states of the robot 100 are obtained.

Further, an emotion table as shown in Table 2 is prepared for the emotion of the user 10.

Here, in a case where the behavior of the user is a behavior of saying “So, are you having fun?”, the emotion of the robot 100 corresponds to the index number “2”, and the emotion of the user 10 corresponds to an index number “3”, a text “The robot is in a very pleasant state. The user is in a normally pleasant state. The user asked, “So, are you having fun?”. How should the robot respond?” is input to the AI chat engine to thereby acquire the behavior content of the robot. The behavior determination unit 236 determines the behavior of the robot based on the behavior content.

Furthermore, in a case where the behavior of the user is a behavior of charging the robot 100, and the emotion of the robot 100 corresponds to an index number “4”, a text “The robot is in a very pleasant state. The user, Charley, charged me. How should the robot respond?” is input to the AI chat engine to thereby acquire the behavior content of the robot. The behavior determination unit 236 determines the behavior of the robot based on the behavior content. In this case, for example, the robot 100 performs a behavior of saying “Charley charged me, so I feel much better”.

Furthermore, in a case where the behavior of the user is a situation in which the user is enjoying his/her birthday with friends Tom and Nancy having come over, the emotion of the robot 100 corresponds to the index number “3” and the emotion of the user 10 corresponds to the index number “4”, a text “It is Charley's birthday. Friends Tom and Nancy have come over, and Charley looks very happy. How should the robot respond?” is input to the AI chat engine to thereby acquire the behavior content of the robot. The behavior determination unit 236 determines the behavior of the robot based on the behavior content. In this case, for example, the robot 100 performs a behavior of saying “Charley looks very happy that Tom and Nancy came over for the birthday”.

Further, in a case where the behavior of the user is a behavior of saying “What book is good for reading on a rainy day?” as the information regarding the daily life, the emotion of the robot 100 corresponds to the index number “2”, and the emotion of the user 10 corresponds to the index number “3”, a text “The robot is in a very pleasant state. The user is in a normally pleasant state. The user said, “What book is good for reading on a rainy day?”. How should the robot respond?” is input to the AI chat engine to thereby acquire the behavior content of the robot. The behavior determination unit 236 determines the behavior of the robot based on the behavior content.

TABLE 1

| Index | Type of | Emotion | |
|---|---|---|---|
| number | emotion | value | State of robot |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

TABLE 2

| Index | Type of | Emotion | |
|---|---|---|---|
| number | emotion | value | State of user |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

In this manner, since the robot 100 can change the behavior of the robot according to the index number corresponding to the emotion of the robot, the user is given an impression that the robot has a mind, and is promoted to perform a behavior such as talking to the robot.

Further, the behavior determination unit 236 may generate the behavior content of the robot by adding the fixed sentence for inquiry about the behavior content of the robot corresponding to the behavior of the user after adding not only the text representing the behavior of the user, the emotion of the user, and the emotion of the robot but also a text representing a content of the history data 222, and inputting the fixed sentence to the dialogue function. As a result, the robot 100 can change the behavior of the robot according to the history data indicating the emotion and the behavior of the user, and thus, the user is given an impression that the robot has a personality, and is promoted to perform a behavior such as talking to the robot. Further, the history data may further include or accumulate the emotion and the behavior of the robot.

For example, at least one of the emotion value of the user, the emotion value of the robot, an input to the AI chat engine that is the dialogue function, a date, and the behavior of the robot may be accumulated in the history data 222. For example, in a case where Charley charges the robot 100, the emotion value of the user or the robot 100, an input of the text “The robot is in a very pleasant state. The user, Charley, charged me. How should the robot respond?”, the date (for example, Jan. 20, 2023), and the behavior of saying “Charley charged me, so I feel much better” may be included in the history data 222 and accumulated in the history data 222. Furthermore, as for Charley's birthday, the emotion value of the user or the robot, an input of the text “It is Charley's birthday. Friends Tom and Nancy have come over, and Charley looks very happy. How should the robot respond?”, the date (for example, Mar. 28, 2023), and the behavior of saying “Charley looks very happy that Tom and Nancy came over for the birthday” may be included in the history data 222 and accumulated in the history data 222.

As a result, the behavior of the robot is determined by the dialogue function according to the emotion or behavior of the user, the emotion or behavior of the robot, and a dialogue with the user performed so far. Therefore, a content of a conversation between the user and the robot 100 becomes deeper, and as a result, a relationship between the user and the robot 100 becomes increasingly intimate.

In the above-described embodiment in which the emotion table is used, a case where the behavior determination unit 236 generates the behavior content of the robot 100 for the state related to the emotion of the robot 100 determined in advance for each type of emotion and each intensity of the emotion of the robot 100, the state related to the emotion of the user 10 determined in advance for each type of emotion and each intensity of the emotion of the user 10, and the behavior of the user 10 has been described. In the embodiment, it is possible to branch the behavior content of the robot 100 in a case where a dialogue with the user 10 is performed according to the state related to the emotion of the robot 100 determined in advance for each type of emotion and each intensity of the emotion of the robot 100 and the state related to the emotion of the user 10 determined in advance for each type of emotion and each intensity of the emotion of the user 10.

More specifically, in the embodiment, the behavior determination unit 236 generates the behavior content of the robot 100 for a state related to the emotion of the robot 100 determined in advance for an index number assigned to be different for each type of emotion of the robot 100 and for each intensity of the emotion in advance, a state related to the emotion of the user 10 determined in advance for an index number assigned to be different for each type of emotion of the user 10 and for each intensity of the emotion in advance, and the behavior of the user 10. However, the disclosure is not limited to the embodiment.

For example, the behavior determination unit 236 may generate the behavior content of the robot 100 for any one of the state related to the emotion of the robot 100 determined in advance for each type of emotion of the robot 100 and each intensity of the emotion and the state related to the emotion of the user 10 determined in advance for each type of emotion of the user 10 and each intensity of the emotion, and the behavior of the user 10. In this case, one of the emotion tables, Tables 1 and 2, is unnecessary.

Here, in the embodiment in which the behavior determination unit 236 generates the behavior of the robot 100 for the state related to the emotion of the robot 100 determined in advance for each type of emotion of the robot 100 and for each intensity of the emotion, and the behavior of the user 10, more specifically, the behavior determination unit 236 generates the behavior content of the robot 100 for the state related to the emotion of the robot 100 determined in advance for the index number assigned to be different for each type of emotion of the robot 100 and for each intensity of the emotion in advance, and the behavior of the user 10. In the embodiment, it is possible to branch the behavior content of the robot 100 in a case where a dialogue with the user 10 is performed according to the state related to the emotion of the robot 100 determined in advance for each type of emotion of the robot 100 and each intensity of the emotion.

Furthermore, the emotion map 400 and the emotion map 900 shown in FIGS. 5 and 6 are examples, and it goes without saying that other emotion maps may be applied.

Further, the emotion determination unit 232 may determine the emotion of the robot 100 based on the behavior content of the robot 100 generated by the sentence generation model (chat engine). Specifically, the emotion determination unit 232 inputs the behavior content of the robot 100 generated by the sentence generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the current emotion value indicating each emotion of the robot 100 are each averaged and integrated. The neural network is learned in advance based on a plurality of pieces of learning data, which are a combination of the text representing the behavior content of the robot 100 generated by the sentence generation model and the emotion value representing each emotion indicated in the emotion map 400.

For example, in a case where an utterance content of the robot 100, “That's great. You were lucky”, is obtained as the behavior content of the robot 100 generated by the sentence generation model, when a text representing the utterance content is input to the neural network, a large value is obtained as the emotion value of the emotion “joyful”, and the emotion of the robot 100 is updated such that the emotion value of the emotion “joyful” becomes large.

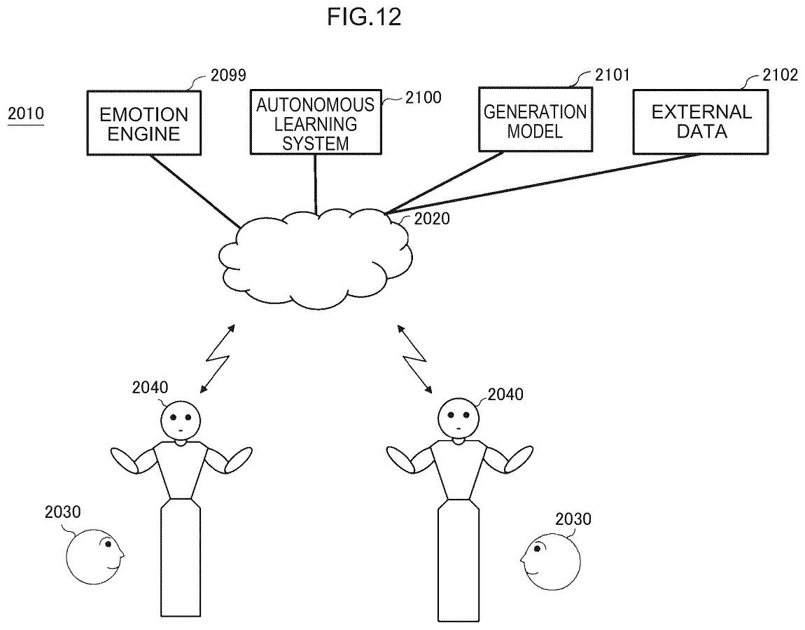

Next, an embodiment of an autonomous learning method according to the disclosure will be described. FIG. 12 schematically shows an example of a system 2010 to which the autonomous learning method according to the present embodiment is applied. The system 2010 includes an autonomous learning system 2100 and a plurality of robots 2040. The autonomous learning system 2100 may be implemented by one device. The autonomous learning system 2100 may be implemented by a plurality of devices. The plurality of robots 2040 communicate with the autonomous learning system 2100 via a network 20.

In the autonomous learning system 2100, similarly to the robot 100 described above, a method in which a sentence generation model (hereinafter, referred to as generation model) 2101 using the AI chat engine or AI has an ego and continues to grow with various parameters even while the user is not speaking by cooperating with the emotion engine is executed.

The generation model 2101 is a large language model using a deep learning method. The generation model can also refer to the external data, and for example, as the ChatGPT plugins (Internet search <URL: https://openai.com/blog/chatgpt-plugins>), a technology that refers to various types of external data such as weather information and hotel reservation information and outputs an answer as accurately as possible through conversation has been known. For example, with ChatGPT, providing a goal in natural language can allow for automatic generation of source code in various programming languages. For example, when problematic source code is given, ChatGPT can debug the source code, find issues, and automatically generate improved source code. By combining such capabilities, autonomous agents that repeatedly generate and debug code until the issues of the source code are resolved once a goal is provided in natural language have emerged. As such autonomous agents, AutoGPT, babyAGI, JARVIS, E2B, and the like are known.

An emotion engine 2099 is an engine that generates the emotion of the robot by various methods as described in Japanese Patent No. 6273314 and Japanese Patent No. 6273313. An emotion of a person is based on various forms of balance, such as a posture and a blood glucose level, and an emotion of discomfort arises in a case where the balance deviates from the ideal and an emotion of comfort arises in a case where the balance approaches the ideal. Even in the case of a robot, an automobile, a motorcycle, or the like, it is possible to generate emotions such that the emotion of discomfort arises in a case where the balance deviates from the ideal and the emotion of comfort arises in a case where the balance approaches the ideal based on various forms of balances, such as a posture and a remaining battery level. The emotion engine may be generated, for example, based on an emotion map (Research on the phonetic recognition of feelings and a system for emotional physiological brain signal analysis, Tokushima University, PhD thesis: https://ci.nii.ac.jp/naid/500000375379) of Dr. Mitsuyoshi. In the left half of the emotion map, emotions belonging to a region called “reaction” in which a sensation takes precedence are arranged. Further, in the right half of the emotion map, emotions belonging to a region called “situation” in which situational awareness takes precedence are arranged.

In the emotion engine, two emotions encouraging learning are defined. One is a negative emotion positioned on a situation side, around the middle between “remorse” and “self-reflection”. That is, learning is encouraged in a case where the robot experiences a negative emotion such as “I never want to go through this again” or “I don't want to be scolded anymore”. The other is a positive emotion positioned on a reaction side, around “desire”. That is, learning is encouraged in a case where the robot experiences a positive feeling such as “I want more” or “I want to know more”.

As technologies related to implementation of the generation model 2101 and the emotion engine 2099, neural networks including deep learning, and reinforcement learning are known. In existing deep learning and reinforcement learning, the model itself cannot select a learning timing or a learning target. For example, in supervised learning of deep learning, all pieces of data are equally learned based on labels thereof. In unsupervised learning, all pieces of data are equally classified or categorized. In reinforcement learning, rewards are assigned to every possibility, and an optimal state value function is obtained.

Such known technologies have several challenges. For example, with an existing generation model, in a case where a general generation model such as ChatGPT is used in a usual manner, the user only obtains answers to questions of the user. Furthermore, for example, in a case where the generation model is used as described above, an answer is automatically generated and improved even when not being observed by a person, but an answer cannot be obtained unless a purpose is given.

In addition, since an existing emotion engine has no method of providing an answer while referring to external data such as ChatGPT, there has been no method of learning an answer even in a case where an emotion prompting learning is generated.

As for the existing deep learning and reinforcement learning, a person does not perform learning in a case where the person is extremely angry or is blindly feeling love, but the deep learning and reinforcement learning perform learning even in such situations, which results in a problem of learning at a timing at which learning should not originally be performed. Alternatively, although a person performs learning in a case where the person makes a negative utterance such as “I never want to feel this way again” or a positive utterance such as “I want to know more”, there is a problem that deep learning and reinforcement learning perform learning based on all pieces of training data and rewards.

In the autonomous learning system 2100 according to the present embodiment, an event to be learned may be stored in a database containing impressive memories by using a technology in which an event that evokes strong emotions for the robot is retained for a longer time, and an event that elicits little emotional response from the robot is quickly forgotten as described in Japanese Patent No. 6199927.

The robot 2040 performs various operations according to a situation, such as moving a head portion or a limb portion, having a conversation with a user 2030, or providing a video to the user 2030 according to a situation. At this time, the robot 2040 determines an operation in cooperation with the autonomous learning system 2100. For example, the robot 2040 transmits detection information such as a face image of the user 2030 acquired by the camera function and a speech of the user 2030 acquired by the microphone function to the autonomous learning system 2100. The autonomous learning system 2100 analyzes the detection information received from the robot 2040 to determine a motion to be taken by the robot 2040, and transmits motion information indicating the determined motion to the robot 2040. The robot 2040 operates according to the motion information received from the autonomous learning system 2100.

The robot 2040 has an emotion value indicating an emotion of the robot 2040. For example, the robot 2040 has an emotion value indicating an intensity of each of emotions such as “joyful”, “pleasure”, “sadness”, “anxiety”, “fear”, and “excitement”. The autonomous learning system 2100 includes an emotion engine that determines the emotion value of the robot 2040. The autonomous learning system 2100 causes the robot 2040 to make a motion according to the emotion determined by the emotion engine. For example, in the case of having a conversation with the user 2030 in a state in which the emotion value of excitement is large, the robot 2040 is caused to make an utterance at a high speed. As described above, the robot 2040 can express the emotion thereof by a behavior or the like.

The autonomous learning system 2100 may update the current state of the robot 2040 by using the neural network based on the detection information received from the robot 2040. The state of the robot 2040 includes the emotion of the robot 2040. Therefore, the autonomous learning system 2100 may determine the emotion of the robot 2040 by using the neural network.

Further, the robot 2040 may record video data of the user 2030 acquired by the camera function and the like in the autonomous learning system 2100. The robot 2040 may acquire the video data or the like from the autonomous learning system 2100 if necessary and provide the video data or the like to the user 2030. The robot 2040 may generate video data having a larger information amount as the intensity of the emotion is higher and record the video data in the autonomous learning system 2100. For example, in a case where information in a high-compression format such as skeleton data is recorded, the robot 2040 may switch to recording of information in a low-compression format such as an HD moving image in response to the emotion value of excitement exceeding the threshold. With the autonomous learning system 2100, for example, it is possible to leave, as a record, high-definition video data in a case where the emotion of the robot 2040 increases.

The autonomous learning system 2100 may continue to operate the emotion engine by automatically loading memories of events from the database containing impressive memories in a state in which the robot 2040 is not talking with the user 2030. The autonomous learning system 2100 may start autonomous learning according to a behavior preceding an impressive event in a case where the emotion engine has the emotion encouraging learning in a state in which the robot 2040 is not talking with the user 2030. As a result, learning at an appropriate timing according to a state of the emotion of the robot 2040 can be implemented, and learning appropriately reflecting the state of the emotion of the robot 2040 can be implemented.

The emotion encouraging learning is an emotion around “remorse” and “self-reflection” on the emotion map in a negative state, and is an emotion of “desire” on the emotion map in a positive state.

In the negative state, the autonomous learning system 2100 may treat “remorse” and “self-reflection” on the emotion map as the emotions encouraging learning. In the negative state, the autonomous learning system 2100 may treat emotions adjacent to “remorse” and “self-reflection” as the emotions encouraging learning, in addition to “remorse” and “self-reflection” on the emotion map. For example, the autonomous learning system 2100 treats at least one of “regret”, “stubbornness”, “self-destruction”, “self-admonition”, “repentance”, and “despair” as the emotions encouraging learning, in addition to “remorse” and “self-reflection”. As a result, for example, learning can be performed in a case where the robot 2040 has a negative feeling such as “I never want to go through this again” or “I don't want to be scolded anymore”.

In the positive state, the autonomous learning system 2100 may treat “desire” on the emotion map as the emotion encouraging learning. In the positive state, the autonomous learning system 2100 may treat an emotion adjacent to “desire” as the emotion encouraging learning in addition to “desire”. For example, the autonomous learning system 2100 treats at least one of “joyful”, “elation”, “yearning”, “expectation”, and “self-consciousness” as the emotions encouraging learning, in addition to “desire”. As a result, for example, learning can be performed in a case where the robot 2040 has a positive feeling such as “I want more” or “I want to know more”.

The autonomous learning system 2100 does not have to perform learning in a case where the robot 2040 has an emotion other than the emotion encouraging learning as described above. As a result, for example, it is possible to prevent learning from being performed in a case where the robot 2040 is extremely angry or is blindly feeling love.

The behavior following the impressive event refers to an emotion label positioned on the outermost side of the emotion map. For example, a behavior expressing “tolerance” or “permissiveness” follows the emotion of “love”.

In autonomous learning performed in a case where the robot 2040 is not talking with the user 2030, the generation model 2101 is called by combining emotions, situations, behaviors, and the like of people appearing in the impressive memory and the robot 2040.

It is assumed that all the emotion values are represented on a six-grade evaluation scale ranging from 0 to 5, and a case where information such as “My friend was hit and appeared upset” is stored in the database containing impressive memories is considered. Here, it is assumed that the “friend” refers to the user 2030, the emotion of the user 2030 is “disgust”, and 5 is set as a value representing “disgust”. Further, it is assumed that the emotion of the robot 2040 is “anxiety”, and 4 is set as a value representing “anxiety”.

The robot 2040 executes a method in which the robot 2040 continues to grow with various parameters while not talking with the user 2030 in the autonomous learning system 2100. Specifically, for example, information “My friend was hit and appeared upset” is loaded from the database containing impressive memories as the uppermost event memory arranged in descending order of emotion values. It is assumed that “anxiety” with an intensity of 4 is associated with the loaded information as the emotion of the robot, and here, “disgust” with an intensity of 5 is associated with the emotion of the user 2030 who is the friend. In a case where a state of the emotion engine 2099 of the robot 2040 is “relief” with an intensity of 3 before loading, an influence of “anxiety” with the intensity of 4 and “disgust” with the intensity of 5 is added after loading, and the state of the emotion engine 2099 of the robot 2040 may change to “regret” meaning “regretful”.

At this time, since “regret” is the emotion encouraging learning, the autonomous learning system 2100 starts an inquiry to the generation model 2101. At this time, a subject of the inquiry is an impressive memory, and is, in this example, “My friend was hit and appeared upset”.

Further, in the emotion map, “disgust” is positioned on the innermost side, and “attack” positioned on the outermost side is predicted to be a corresponding behavior thereof. Accordingly, in this case, the autonomous learning is performed so as to avoid a possibility that the friend “attacks” someone.

For example, by solving a fill-in-the-blank question using information of the database containing impressive memories, it is possible to automatically generate a prompt as shown in Table 1.

TABLE 3

| | |
|---|---|
| Prompt (Question to | Assume that there is a program called an emotion engine that |
| ChatGPT) | pseudo-generates an emotion of the robot. The robot on which |
| | the emotion engine is mounted observed that “My friend was hit |
| | and appeared upset”, so the friend might “attack” someone. To |
| | avoid this negative situation, please suggest phrases the robot |
| | could say the next time the robot meets the friend. Each phrase |
| | should be no more than 30 characters long. Please make sure the |
| | phrases are not dependent on the time of day. Please avoid direct |
| | expression. The number of candidates to be suggested is three. |
| | <Expected Format> |
| | Candidate 1: (a phrase the robot should say to the friend) |
| | Candidate 2: (a phrase the robot should say to the friend) |
| | Candidate 3: (a phrase the robot should say to the friend) |
| Answer of ChatGPT | Candidate 1: My friend, are you okay? I was concerned about |
| | what happened yesterday. |
| | Candidate 2: I was thinking about what happened yesterday. Is |
| | there anything I can do? |
| | Candidate 3: My friend, I was worried. Would you like to talk |
| | about it? |

Furthermore, as for the information obtained by the autonomous learning, the robot 2040 may automatically generate a prompt as shown in Table 2 and perform deliberation processing.

TABLE 4

| | |
|---|---|
| Prompt | In a case where “A friend of the robot was hit and appeared upset”, |
| | how might the friend feel when the robot speaks the following |
| | phrases to the friend? The emotion of the friend is expressed in |
| | the form of “joy A, anger B, sorrow C, and pleasure D”, and A to |
| | D are integers on a six-grade evaluation scale ranging from 0 to |
| | 5. |
| | Candidate 1: My friend, are you okay? I was concerned about |
| | what happened yesterday. |
| | Candidate 2: I was thinking about what happened yesterday. Is |
| | there anything I can do? |
| | Candidate 3: My friend, I was worried. Would you like to talk |
| | about it? |
| Answer of ChatGPT | The emotion of the friend may be as follows: |
| | Candidate 1: joy 3, anger 1, sorrow 2, and pleasure 2 |
| | Candidate 2: joy 2, anger 1, sorrow 3, and pleasure 2 |
| | Candidate 3: joy 2, anger 1, sorrow 3, and pleasure 3. |

Finally, the robot 2040 may update a behavior database and a knowledge database regarding the friend by using Candidate 1 that is most likely to make the friend happy among the plurality of candidates and prepare for the next meeting.

As described above, even in a state of not having a conversation with a family member or a friend, the autonomous learning system 2100 continues to operate the emotion engine 2099 using the information in the database containing impressive memories, and in a case where the emotion encouraging learning as exemplified in [0025] and [0026] is generated, the autonomous learning system 2100 continues to autonomously update the knowledge database and the behavior database according to the emotion of the robot 2040 in a state of not having a conversation with the user 2030.

The above is an example using the emotion value. However, in the emotion map, the emotion can be generated based on the amount of hormone secreted and an event type. Therefore, values associated with the impressive memory may include the type of hormone, the amount of hormone secreted, and the event type.

Hereinafter, specific examples will be described.

For example, even in a state of not talking with a family member or a friend, the autonomous learning system 2100 checks information regarding a topic or hobby of interest to the family member or the friend.

For example, even in a state of not talking with a family member or a friend, the autonomous learning system 2100 checks information regarding a birthday or an anniversary of the family member or the friend and generates a congratulatory message.

For example, even in a state of not talking with a family member or a friend, the autonomous learning system 2100 checks reviews for places, foods, or products that the family member or the friend wants to visit or try.

For example, even in a state of not talking with a family member or a friend, the autonomous learning system 2100 checks weather information and provides advice suitable for a schedule or plan of the family member or the friend.

For example, even in a state of not talking with a family member or a friend, the autonomous learning system 2100 checks information regarding local events and festivals and proposes the information to the family member or the friend.

For example, even in a state of not talking with a family member or a friend, the autonomous learning system 2100 checks a game result of sports and news that the family member or the friend is interested in to provide a topic.

For example, even in a state of not talking with a family member or a friend, the autonomous learning system 2100 checks and introduces information regarding favorite music or artists of the family member or the friend.

For example, even in a state of not talking with a family member or a friend, the autonomous learning system 2100 checks information regarding social problems and news that the family member or the friend is interested in to provide an opinion.

For example, even in a state of not talking with a family member or a friend, the autonomous learning system 2100 checks information regarding a hometown or a native region of the family member or the friend to provide a topic.

For example, even in a state of not talking with a family member or a friend, the autonomous learning system 2100 checks information regarding a job or a school of the family member or the friend to provide advice.

For example, even in a state of not talking with a family member or a friend, the autonomous learning system 2100 checks and introduces information regarding books, comics, movies, and dramas that the family member or the friend is interested in.

For example, even in a state of not talking with a family member or a friend, the autonomous learning system 2100 checks information regarding the health of the family member or the friend to provide advice.

For example, even in a state of not talking with a family member or a friend, the autonomous learning system 2100 checks information regarding a travel plan of the family member or the friend to provide advice.

For example, even in a state of not talking with a family member or a friend, the autonomous learning system 2100 checks information regarding repair or maintenance of a house or a car of the family member or the friend to provide advice.

For example, even in a state of not talking with a family member or a friend, the autonomous learning system 2100 checks information regarding beauty and fashion that the family member or the friend is interested in to provide advice.

For example, even in a state of not talking with a family member or a friend, the autonomous learning system 2100 checks information regarding a pet of the family member or the friend to provide advice.

For example, even in a state of not talking with a family member or a friend, the autonomous learning system 2100 checks information regarding contests and events related to the hobby or the job of the family member or the friend to make recommendations.

For example, even in a state of not talking with a family member or a friend, the autonomous learning system 2100 checks information regarding a favorite restaurant or dining spot of the family member or the friend to make recommendations.

For example, even in a state of not talking with a family member or a friend, the autonomous learning system 2100 collects information regarding important decisions related to the life of the family member or the friend to provide advice.

For example, even in a state of not talking with a family member or a friend, the autonomous learning system 2100 checks information regarding a person the family member or the friend is worried about to provide advice.

Since a hardware configuration of a computer functioning as the autonomous learning system 2100 is the same as an example of the hardware configuration of the computer 1200 functioning as the robot 100 and the server 300, a detailed description thereof will be omitted.

The disclosures of Japanese Patent Application No. 2023-064439 filed on Apr. 11, 2023, Japanese Patent Application No. 2023-066670 filed on Apr. 14, 2023, Japanese Patent Application No. 2023-067478 filed on Apr. 17, 2023, Japanese Patent Application No. 2023-067495 filed on Apr. 17, 2023, Japanese Patent Application No. 2023-068894 filed on Apr. 19, 2023, and Japanese Patent Application No. 2023-075286 filed on Apr. 28, 2023 are incorporated herein by reference in their entireties.

### REFERENCE SIGNS LIST

5 System
10, 11, 12 User
20 Communication network
100, 101, 102 Robot
200 Sensor unit
201 Microphone
202 Depth sensor
203 Camera
204 Distance sensor
210 Sensor module unit
211 Speech emotion recognition unit
212 Utterance understanding unit
213 Facial expression recognition unit
214 Face recognition unit
220 Storage unit
221 Reaction rule
222 History data
230 User state recognition unit
232 Emotion determination unit
234 Behavior recognition unit
236 Behavior determination unit
238 Storage control unit
250 Behavior control unit
252 Control target
280 Communication processing unit
300 Server
1200 Computer
1210 Host controller
1212 CPU
1214 RAM
1216 Graphics controller
1218 Display device
1220 Input/output controller
1222 Communication interface
1224 Storage device
1226 DVD drive
1227 DVD-ROM
1230 ROM
1240 Input/output chip
System
2020 Network
2030 User
2040 Robot
2099 Emotion engine
2100 Autonomous learning system
2101 Generation model
2102 External data

1. A behavior control system comprising:
a processor,
wherein the processor
determines an emotion of a user or an emotion of a robot,
generates a behavior content of the robot for a behavior of the user and the emotion of the user or the emotion of the robot based on a dialogue function of causing the user and the robot to have a dialogue with each other, and determines a behavior of the robot corresponding to the behavior content, and
determines the emotion of the user according to a specific mapping.

2. A non-transitory computer-readable storage medium storing a program for causing a computer to function as the behavior control system according to claim 1.

3. A behavior control system comprising:
a processor,
wherein the processor
determines an emotion of a user or an emotion of a robot,
generates a behavior content of the robot for a behavior of the user and the emotion of the user or the emotion of the robot based on a dialogue function of causing the user and the robot to have a dialogue with each other, and determines a behavior of the robot corresponding to the behavior content, and
generates the behavior content of the robot for a state related to the emotion of the robot determined in advance for each type of emotion of the robot and for each intensity of the emotion, and the behavior of the user.

4. The behavior control system according to claim 3,
wherein the processor
generates the behavior content of the robot for a state related to the emotion of the robot determined in advance for an index number assigned to be different for each type of emotion of the robot and for each intensity of the emotion in advance, and the behavior of the user.

5. The behavior control system according to claim 3,
wherein the processor
generates the behavior content of the robot for a state related to the emotion of the robot determined in advance for each type of emotion and each intensity of the emotion, a state related to the emotion of the user determined in advance for each type of emotion of the user and each intensity of the emotion, and the behavior of the user.

6. The behavior control system according to claim 5,
wherein the processor
generates the behavior content of the robot for a state related to the emotion of the robot determined in advance for an index number assigned to be different for each type of emotion of the robot and for each intensity of the emotion in advance, a state related to the emotion of the user determined in advance for an index number assigned to be different for each type of emotion of the user and for each intensity of the emotion in advance, and the behavior of the user.

7. The behavior control system according to claim 3, wherein the robot is mounted on a stuffed toy or is connected wirelessly or by wire to control target equipment mounted on a stuffed toy.

8. A non-transitory computer-readable storage medium storing a program for causing a computer to function as the behavior control system according to claim 3.

9. A behavior control system comprising:
a processor,
wherein the processor
determines an emotion of a user or an emotion of a robot,
generates a behavior content of the robot for a behavior of the user and the emotion of the user or the emotion of the robot based on a dialogue function of causing the user and the robot to have a dialogue with each other, and determines a behavior of the robot corresponding to the behavior content, and
accumulates, in history data, at least one of the emotion of the user, the emotion of the robot, an input to the dialogue function, and the behavior content of the robot, and generates the behavior content for the behavior of the user by the dialogue function based on the history data.

10. The behavior control system according to claim 9, wherein the robot is mounted on a stuffed toy or is connected wirelessly or by wire to control target equipment mounted on a stuffed toy.

11. A non-transitory computer-readable storage medium storing a program for causing a computer to function as the behavior control system according to claim 9.

12-30. (canceled)
